(19) United States
(12) Patent Application Publication
(10) Pub. No.: US 2025/0383527 A1
(43) Pub. Date: Dec. 18, 2025

(54) OPTICAL SYSTEM

(71) Applicant: SIGMA CORPORATION, Kanagawa (JP)

(72) Inventor: Kyosuke MURAKAMI, Tokyo (JP)

(73) Assignee: SIGMA CORPORATION, Kanagawa (JP)

(21) Appl. No.: 19/219,062

(22) Filed: May 27, 2025

(30) Foreign Application Priority Data
Jun. 12, 2024 (JP) 2024-094975

(51) Int. Cl. G02B 9/12

(52) U.S. Cl. CPC G02B 9/12

(57) ABSTRACT

An optical system that achieves weight reduction while correcting various aberrations such as chromatic aberration at a large aperture ratio by arranging lens materials appropriately. An optical system includes, in order from an object side: a first lens group G1 having a negative refractive power; a second lens group G2 that moves along an optical axis during focusing from infinity to a short distance; and a last lens group GL that is disposed closest to the image surface side, in which an aperture diaphragm S is provided between the second lens group G2 and the last lens group GL.

### TECHNICAL FIELD

The present invention relates to an optical system suitable for a lens used in an imaging apparatus such as a still camera or a video camera, or a projection apparatus. In particular, the present invention relates to a technique for achieving weight reduction while effectively correcting various aberrations at a large aperture ratio by arranging lens materials appropriately.

### BACKGROUND ART

In recent years, with an increase in the number of pixels of digital cameras and the like, there is a demand for high optical performance in which various aberrations are highly corrected.

In addition, in order to achieve high-speed and accurate focus operation or wobbling, it is desired to reduce the weight of the focusing lens group.

Therefore, in the optical system proposed in the related art, a configuration in which the weight is reduced by fixing the lens group from the object side to the aperture diaphragm during focus driving and disposing the focusing lens group on the image side of the aperture diaphragm has been proposed.

### RELATED ART DOCUMENT

### Patent Document

[Patent Document 1] Japanese Patent No. 7134697
[Patent Document 2] JP-A-2016-009170A

### SUMMARY OF THE INVENTION

### Problem that the Invention is to Solve

The optical system disclosed in Patent Document 1 achieves high optical performance with a bright wide angle of view by appropriately designating a lens configuration before and after the aperture diaphragm. However, there is a problem that the weight of the focusing lens group tends to be heavy due to a relationship in which the lens configuration before and after the aperture diaphragm is appropriately maintained even during focusing.

In the optical system disclosed in Patent Document 2, an optical system in which the weight of the focusing lens group is suppressed at a large aperture ratio is proposed. However, the longitudinal chromatic aberration, the lateral chromatic aberration, and the sagittal coma flare are not sufficiently corrected. In addition, there is a problem that the total lens length is likely to be long and the overall length is apt to become large.

The present invention has been made in view of the above-mentioned problems, and an object of the present invention is to provide an optical system that achieves weight reduction while correcting various aberrations such as chromatic aberration at a large aperture ratio by arranging lens materials appropriately.

### Means for Solving the Problem

The optical system according to the present invention includes, in order from an object side: a first lens group G1 having a negative refractive power; a second lens group G2 that moves along an optical axis during focusing from infinity to a short distance; and a last lens group GL that is disposed closest to the image surface side, in which an aperture diaphragm S is provided between the second lens group G2 and the last lens group GL.

### Advantage of the Invention

According to the optical system of the present invention, it is possible to provide an optical system that achieves weight reduction while correcting various aberrations such as chromatic aberration at a large aperture ratio by arranging lens materials appropriately.

### BRIEF DESCRIPTION OF THE DRAWINGS

FIG. 1 is a lens cross-sectional view of an optical system at infinity of Example 1.

FIG. 2 is a longitudinal aberration diagram of the optical system at infinity of Example 1.

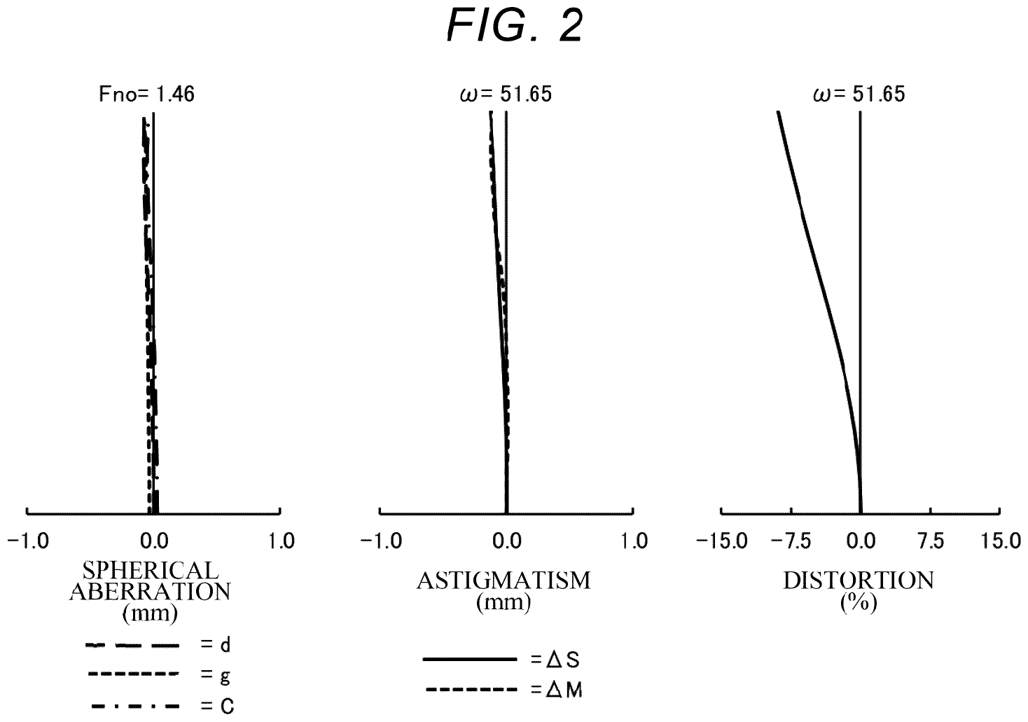

FIG. 3 is a longitudinal aberration diagram of the optical system at a focusing distance of 170 mm of Example 1.

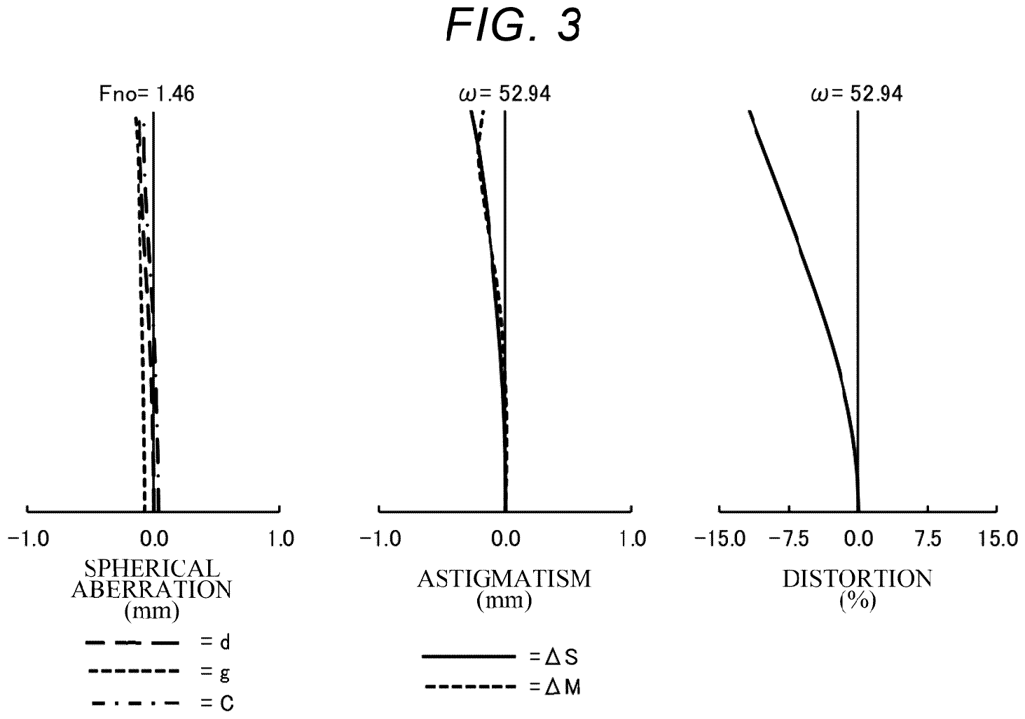

FIG. 4 is a lateral aberration diagram of the optical system at infinity of Example 1.

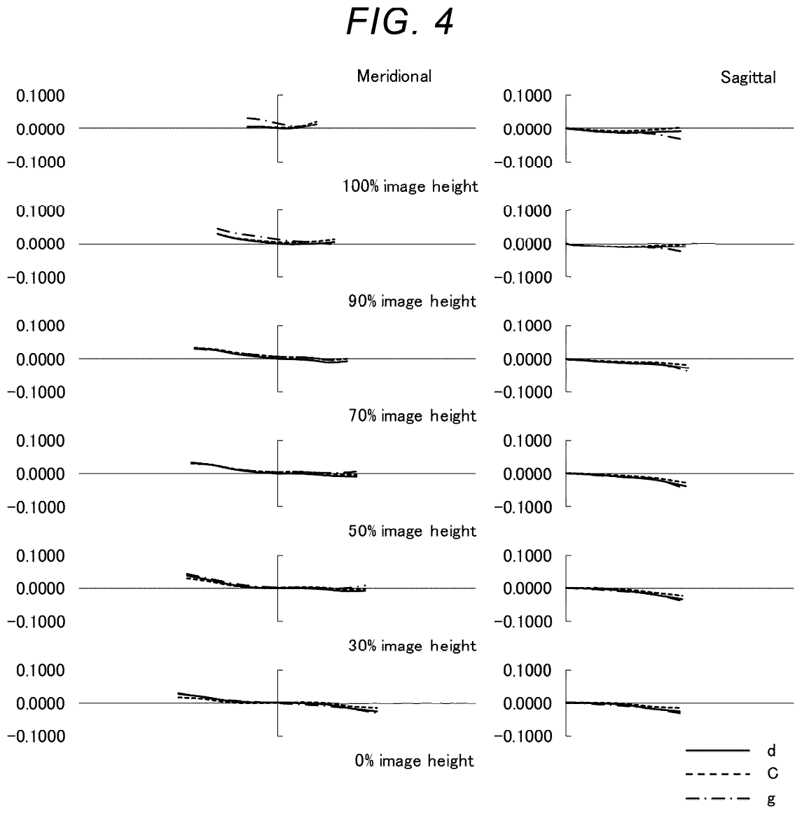

FIG. 5 is a lateral aberration diagram of the optical system at a focusing distance of 170 mm of Example 1.

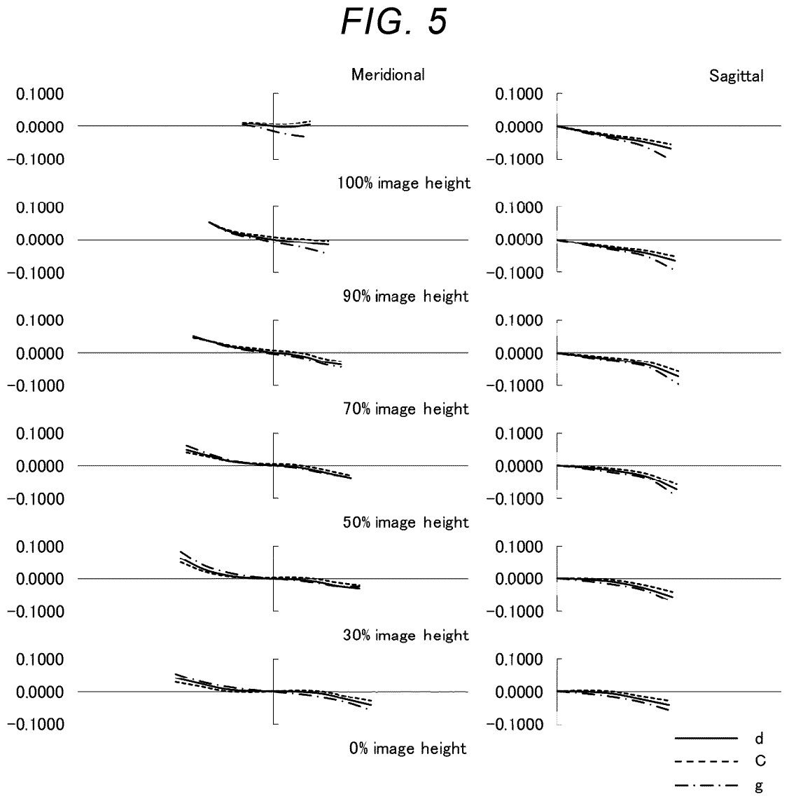

FIG. 6 is a lens cross-sectional view of an optical system at infinity of Example 2.

FIG. 7 is a longitudinal aberration diagram of the optical system at infinity of Example 2.

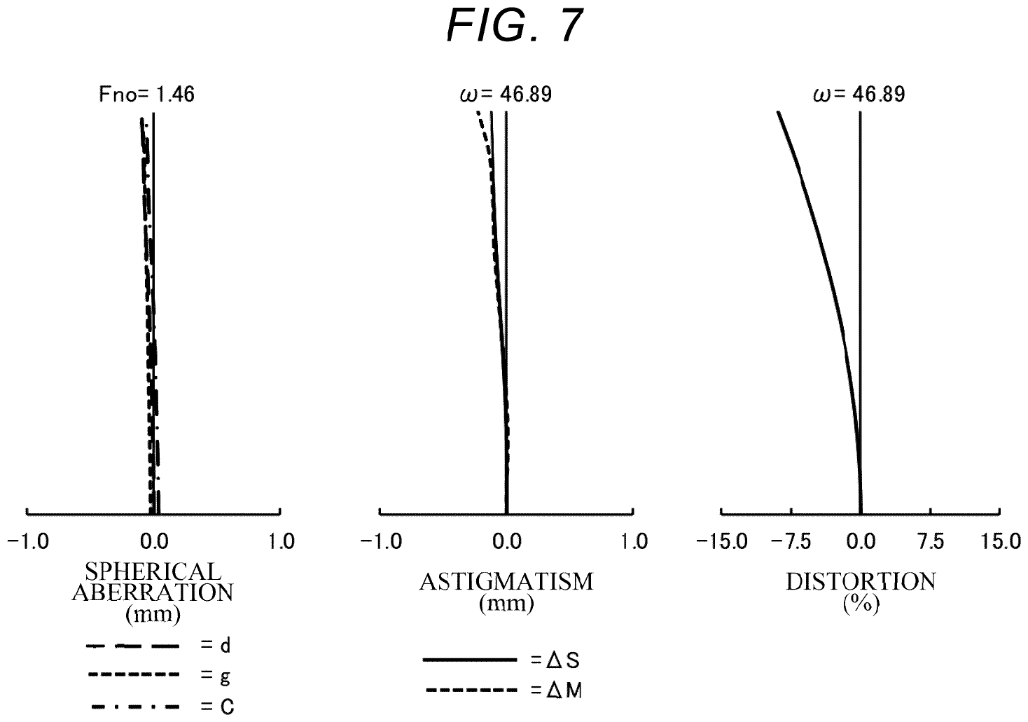

FIG. 8 is a longitudinal aberration diagram of the optical system at a focusing distance of 168 mm of Example 2.

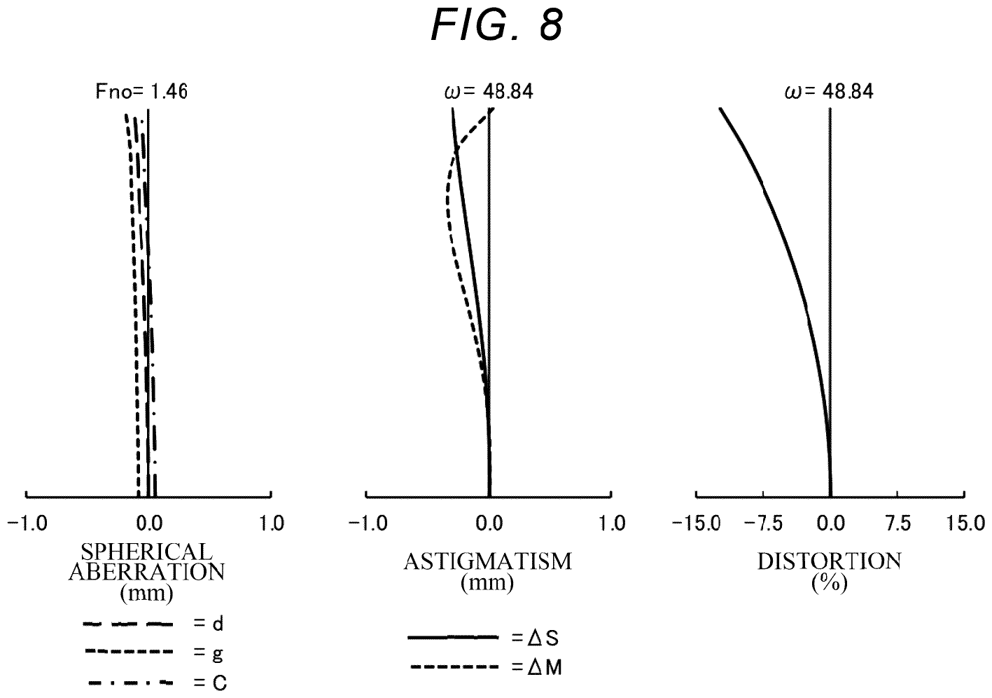

FIG. 9 is a lateral aberration diagram of the optical system at infinity of Example 2.

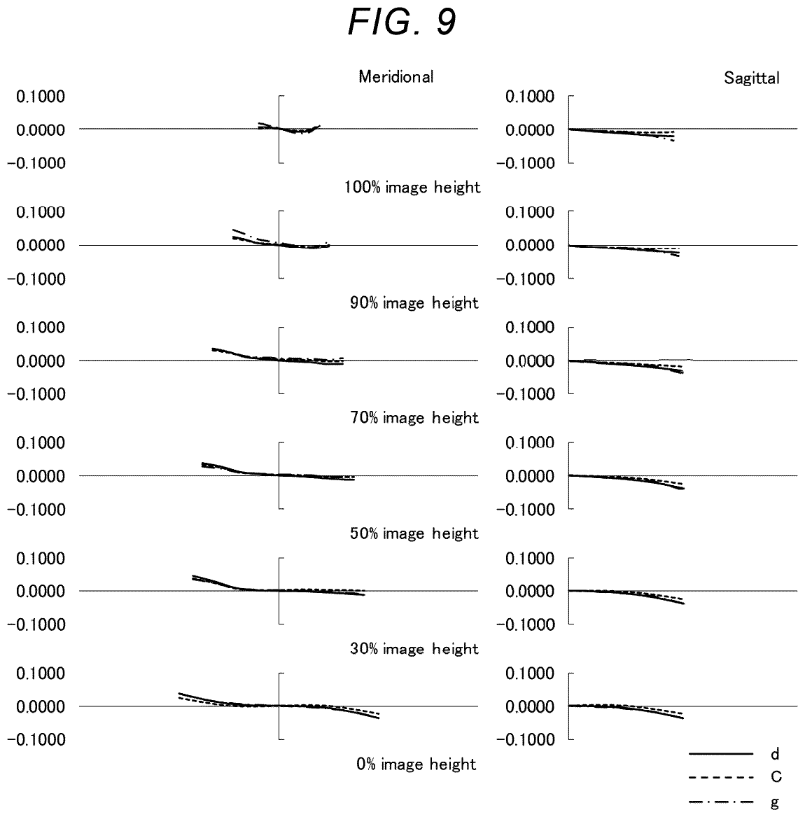

FIG. 10 is a lateral aberration diagram of the optical system at a focusing distance of 168 mm of Example 2.

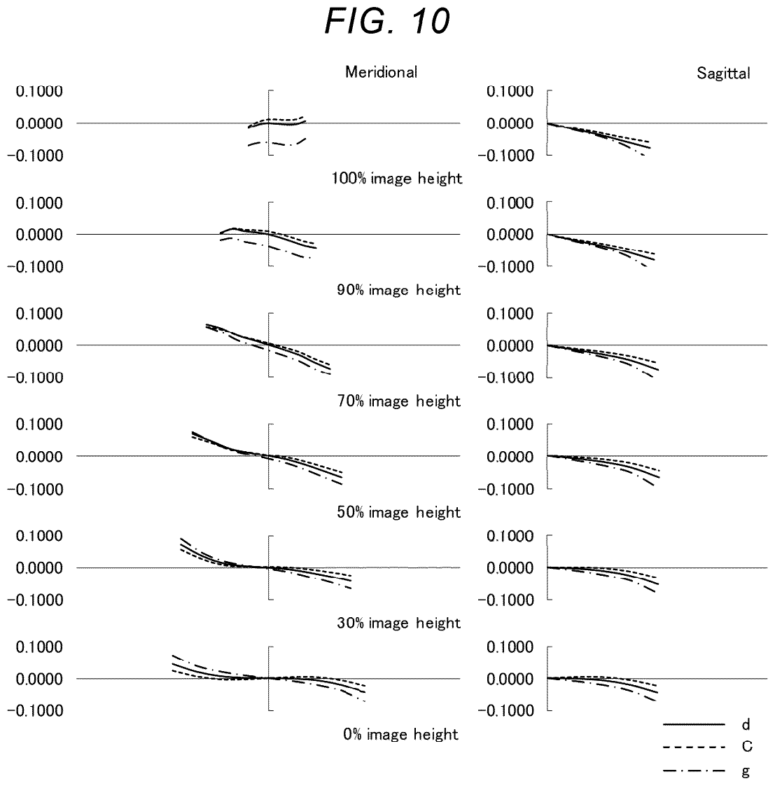

FIG. 11 is a lens cross-sectional view of an optical system at infinity of Example 3.

FIG. 12 is a longitudinal aberration diagram of the optical system at infinity of Example 3.

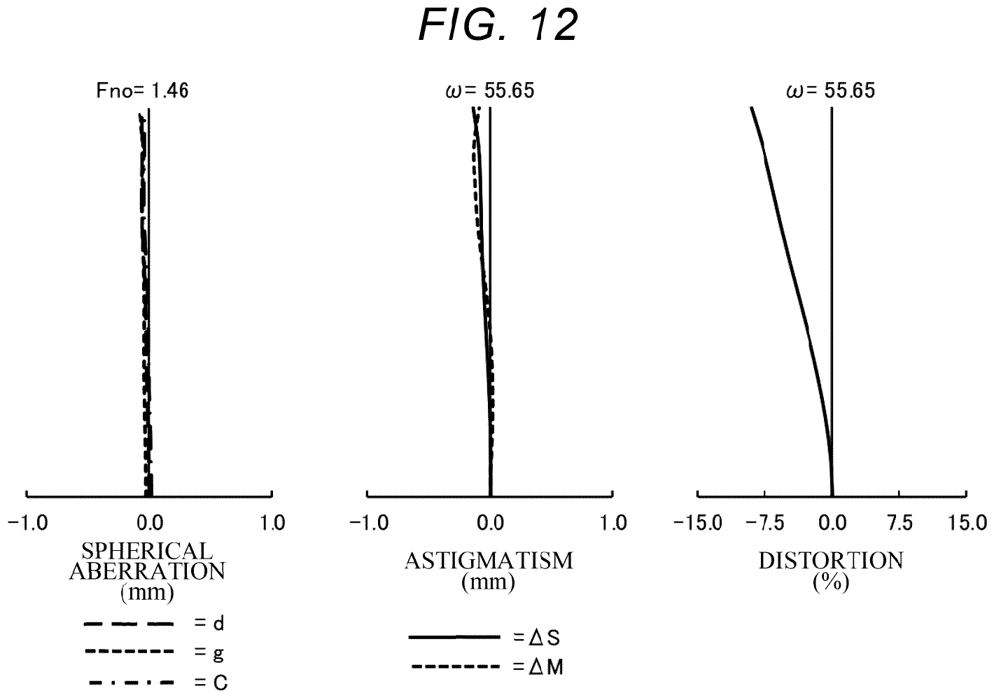

FIG. 13 is a longitudinal aberration diagram of the optical system at a focusing distance of 166 mm of Example 3.

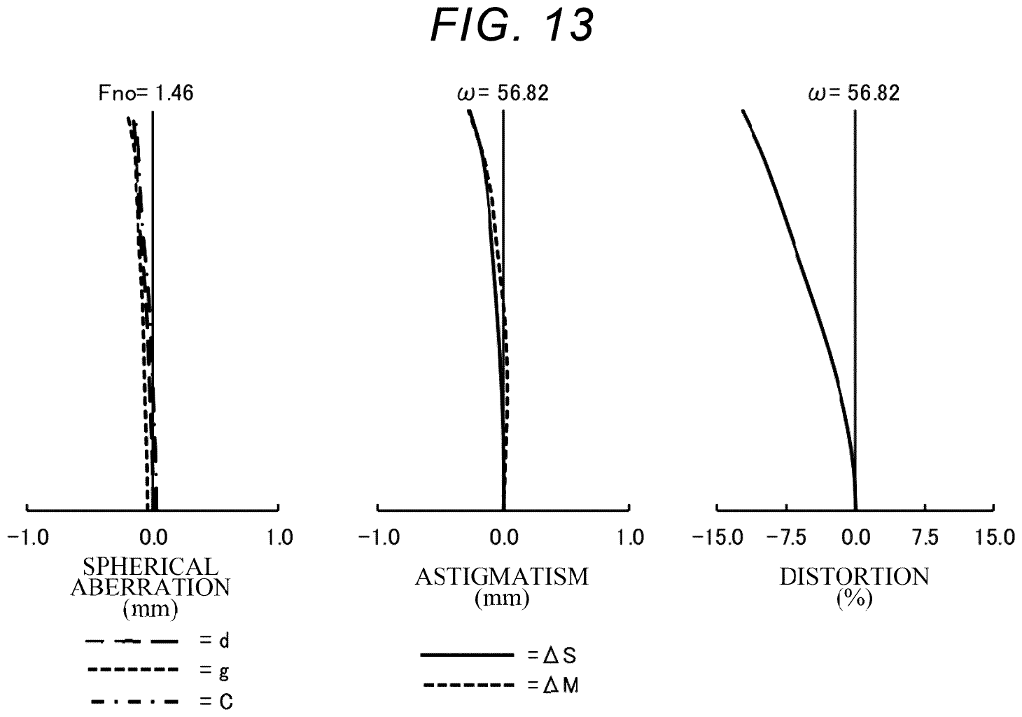

FIG. 14 is a lateral aberration diagram of the optical system at infinity of Example 3.

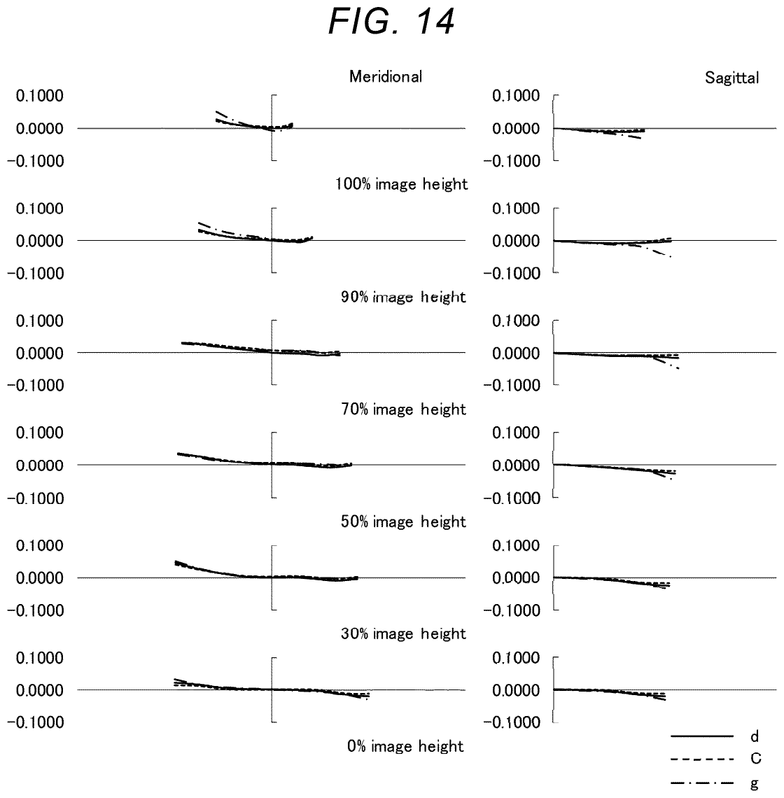

FIG. 15 is a lateral aberration diagram of the optical system at a focusing distance of 166 mm of Example 3.

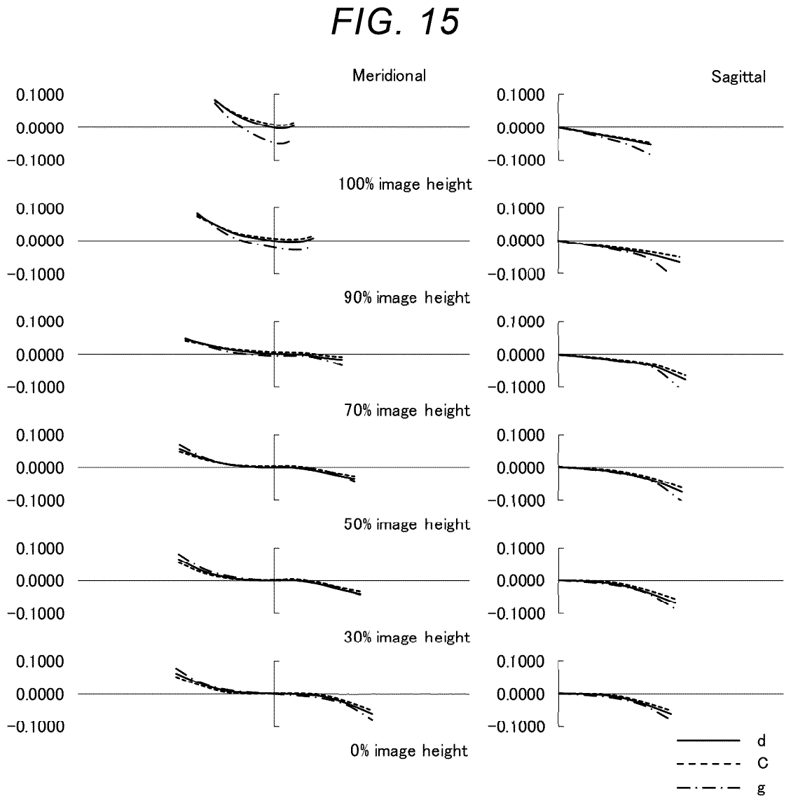

FIG. 16 is a lens cross-sectional view of an optical system at infinity of Example 4.

FIG. 17 is a longitudinal aberration diagram of the optical system at infinity of Example 4.

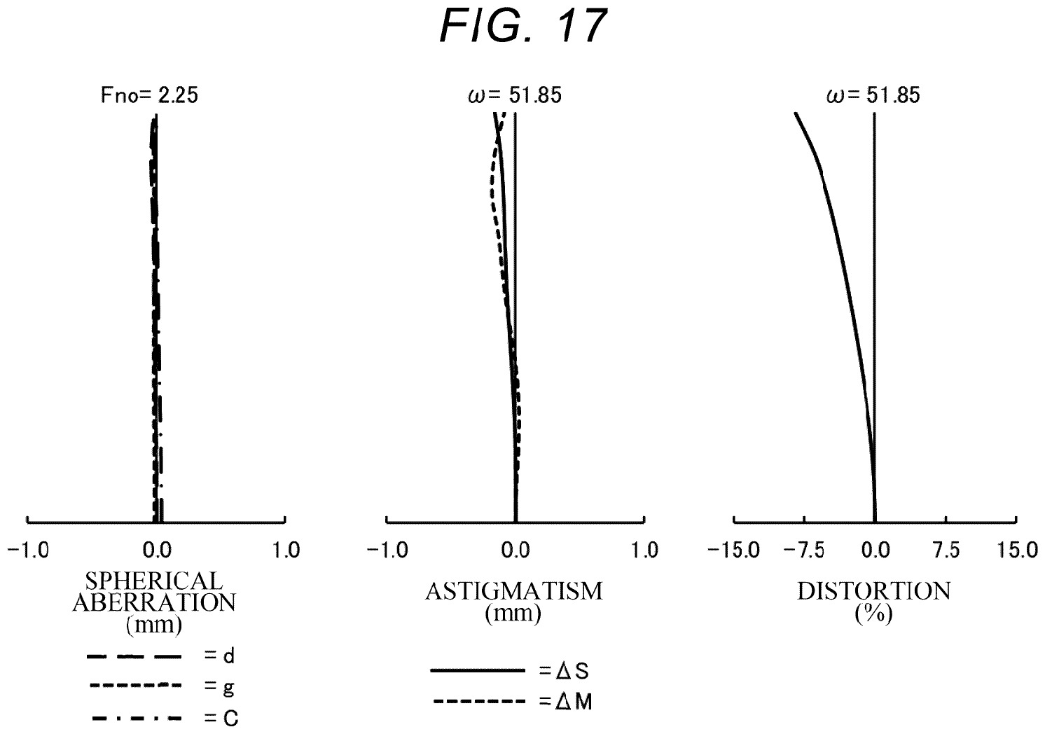

FIG. 18 is a longitudinal aberration diagram of the optical system at a focusing distance of 355 mm of Example 4.

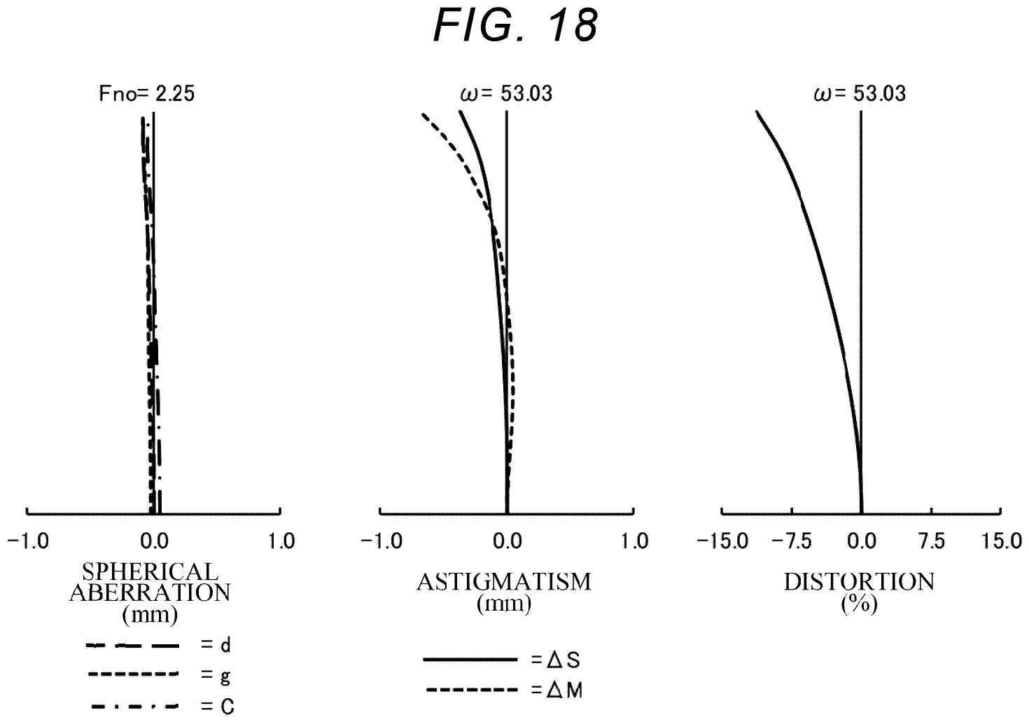

FIG. 19 is a lateral aberration diagram of the optical system at infinity of Example 4.

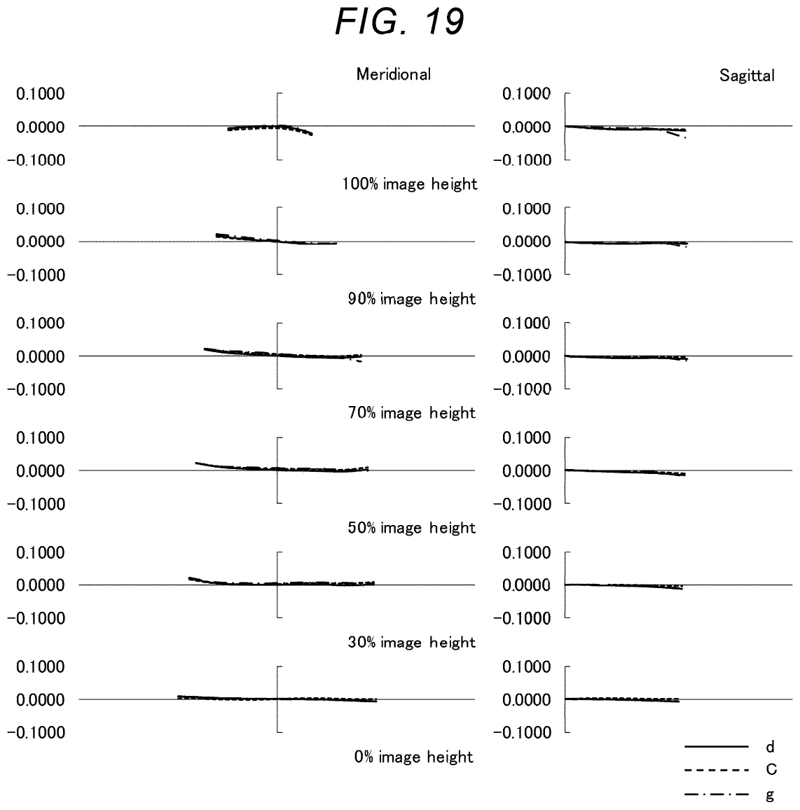

FIG. 20 is a lateral aberration diagram of the optical system at a focusing distance of 355 mm of Example 4.

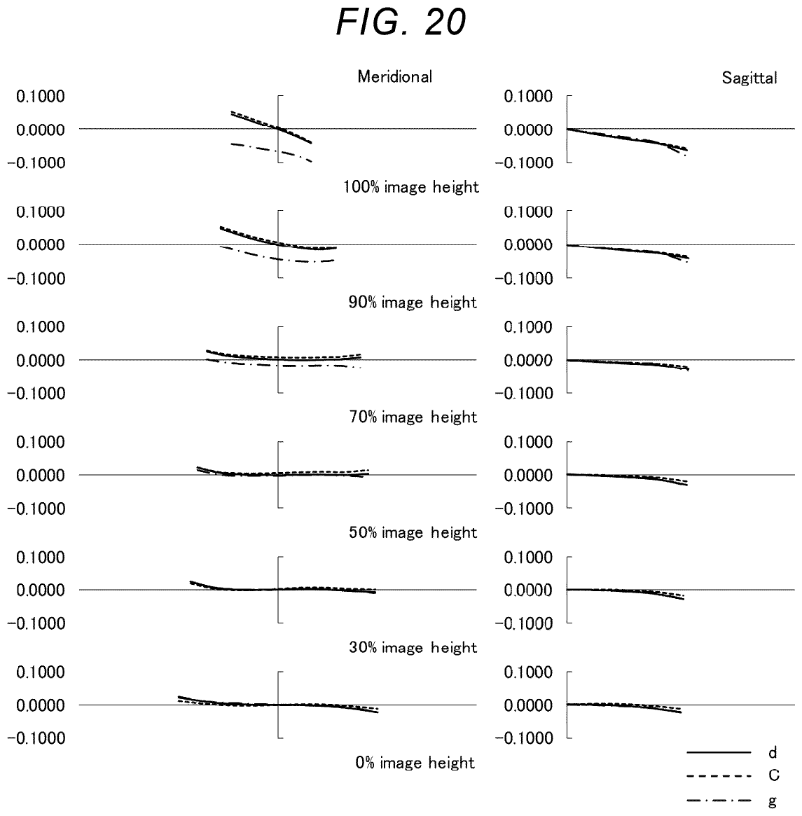

FIG. 21 is a lens cross-sectional view of an optical system at infinity of Example 5.

FIG. 22 is a longitudinal aberration diagram of the optical system at infinity of Example 5.

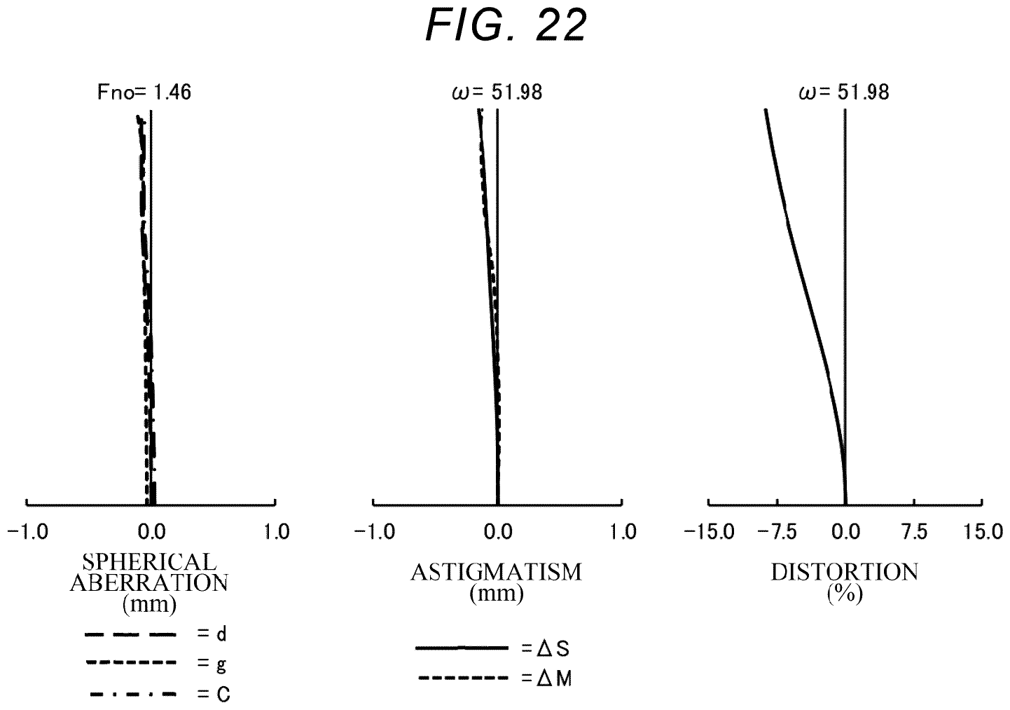

FIG. 23 is a longitudinal aberration diagram of the optical system at a focusing distance of 165 mm of Example 5.

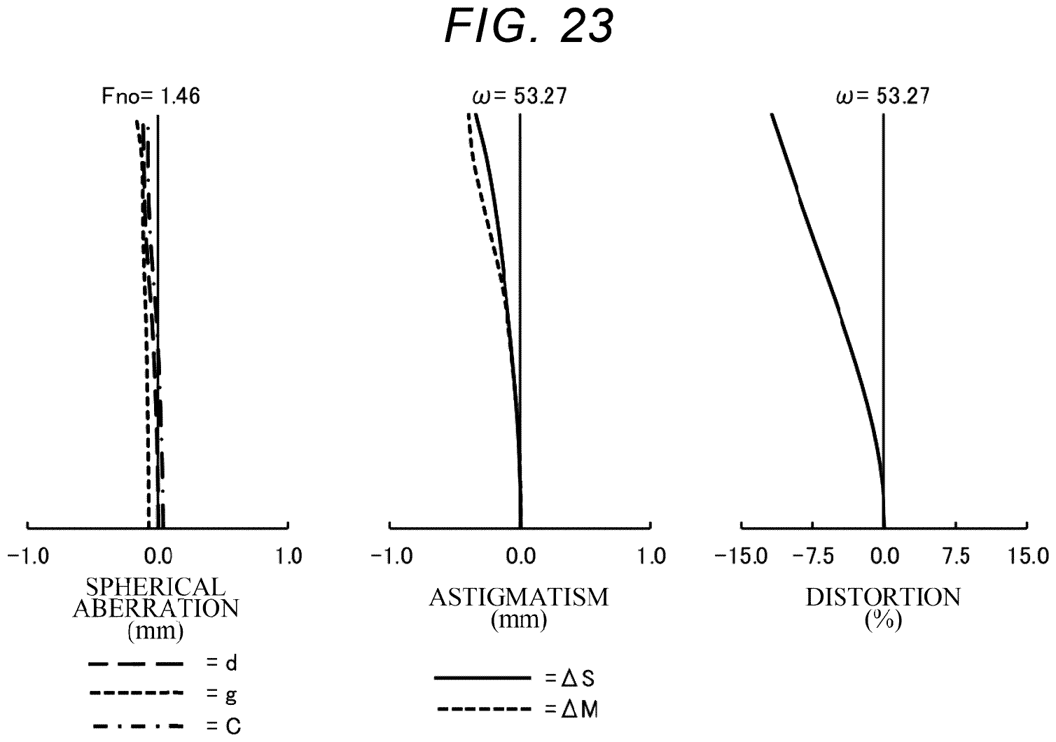

FIG. 24 is a lateral aberration diagram of the optical system at infinity of Example 5.

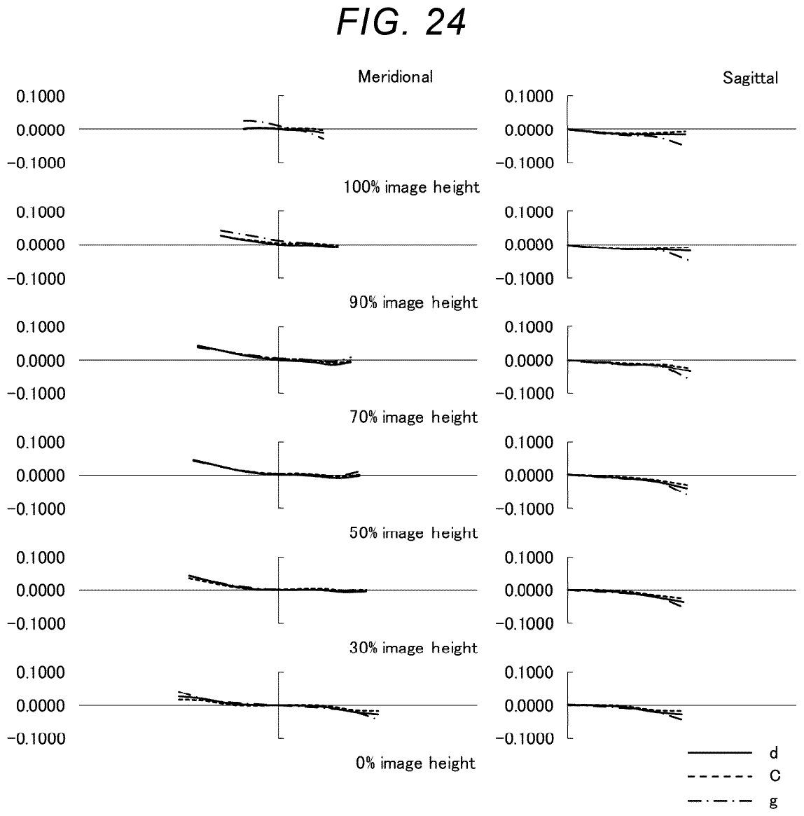

FIG. 25 is a lateral aberration diagram of the optical system at a focusing distance of 165 mm of Example 5.

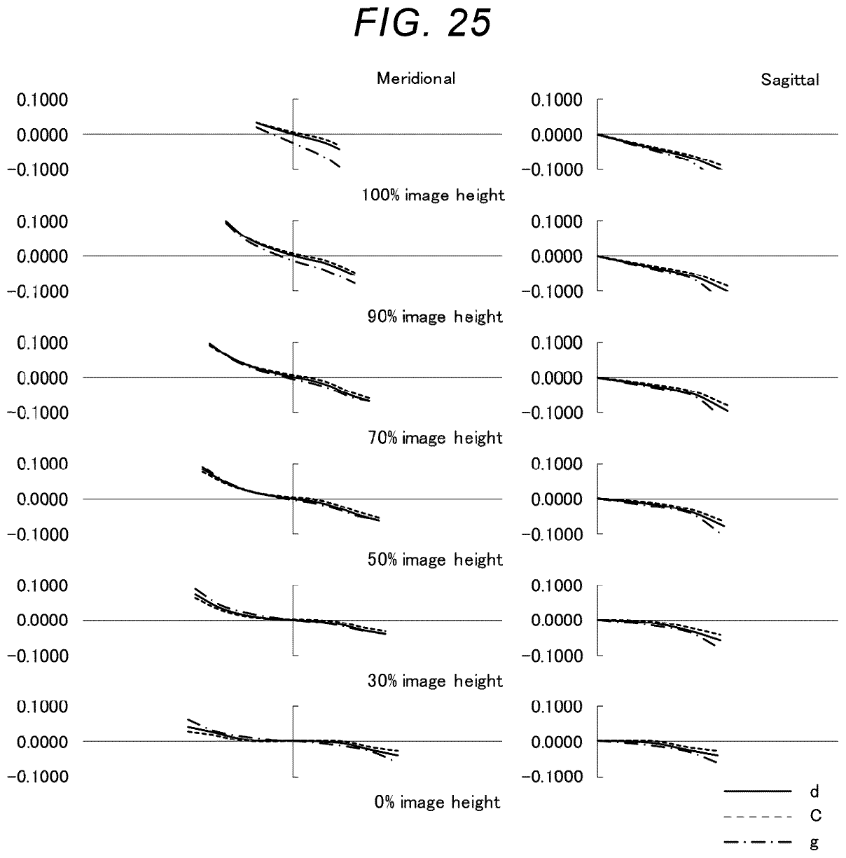

### EMBODIMENTS FOR CARRYING OUT THE INVENTION

Examples of the optical system according to the embodiment of the present invention will be described in detail. The following description of examples describes an example of the optical system according to the embodiment of the present invention, and the present invention is not limited to the description of the present examples within a range not departing from the gist of the present invention.

The optical system of the present invention includes, in order from the object side, a first lens group G1 having a negative refractive power, a second lens group G2 that moves along the optical axis during focusing from the infinity to the short distance, and a last lens group GL that is disposed closest to the image surface side, and the optical system includes an aperture diaphragm S between the second lens group G2 and the last lens group GL.

In general, the difference between the on axis ray height and the off-axis ray height increases as the distance from the aperture diaphragm increases and as the angle of view increases, and is particularly noticeable in a lens disposed closer to the object side than the stop. Therefore, in an optical system having a wide angle of view in which the half angle of view exceeds 45 degrees, such as the optical system according to the embodiment of the present invention, it is difficult to simultaneously correct both on-axis aberration and off-axis aberration at a position closer to the object side than the aperture diaphragm.

In a case where the correction of off-axis aberration, particularly, field curvature or astigmatism is performed, on the object side with respect to the aperture diaphragm, it is effective means to gradually bend off-axis rays in a lens on the object side, in which a difference between the heights of rays on the on-axis and off-axis is large. However, in a case where such a method is adopted, the number of lenses closer to the object side than the aperture diaphragm is likely to increase, and the total lens length increases. In addition, the diameter of the lens closest to the object side increases, and the weight of the product significantly increases.

On the other hand, in order to correct various aberrations generated on the object side of the aperture diaphragm in another group, a lens configuration from the aperture diaphragm to the image side is important. In order to offset aberrations generated closer to the object side than the aperture diaphragm, aberrations with opposite signs need to be generated closer to the image side than the aperture diaphragm, and aberration correction needs to be performed as the entire optical system. Therefore, it is necessary to increase the size of the image side optical system to control aberrations, and it is difficult to achieve reduction in size and weight. In addition, in a case where the aberration that needs to be corrected on the image side is large and the focus is performed on the image side with respect to the aperture diaphragm, it is necessary to provide a focusing lens group in which the aberration is sufficiently corrected with a plurality of lenses, and it is difficult to secure a space.

Therefore, in the present invention, by disposing the first lens group G1 having a negative refractive power and the second lens group G2 that moves during focusing in order from the side closest to the object side, the first lens group G1 can reduce the incidence angle by the negative refractive power, and the incidence angle of the off axis ray incident on the second lens group G2 can be relaxed while correcting various aberrations in the first lens group G1, and the variation in aberration occurring during focusing can be suppressed.

Further, by disposing the aperture diaphragm S between the second lens group G2 and the last lens group GL, the aberrations of off-axis rays can be appropriately separated by the first lens group G1 disposed on the object side and the last lens group GL disposed on the image side with respect to the aperture diaphragm S, and it is possible to correct off-axis aberrations while preventing the entire lens from becoming large.

In addition, in the optical system according to the embodiment of the present invention, it is preferable that the last lens group GL is composed of a positive lens LP and a negative lens LN arranged in order from the object side. The last lens group GL is disposed at a position where a difference between an on-axis ray height and an off-axis ray height is large. By disposing the positive lens LP on the object side of the last lens group GL, it is possible to highly bend the upper ray of the off-axis ray, particularly the off-axis luminous flux. Accordingly, the height of the ray incident on the negative lens LN can be reduced, and the diameter of the lens near the mount can be reduced. By disposing the negative lens LN closest to the image surface side, the back focus can be shortened by deflecting the off-axis ray of which the ray height is once decreased by the positive lens LP to shorten the total lens length.

In addition, in the optical system according to the embodiment of the present invention, it is preferable that the second lens group G2 moves from the image side to the object side during focusing from the infinity distance to the short distance. By moving the second lens group G2 from the image side to the object side during focusing, there is an effect of suppressing flare at the time of the close range. Further, since the configuration is such that it is easy to ensure the amount of light, the diameter of the second lens group G2 can be designed to be small. Thus, there is an advantage in achieving reduction in size.

In addition, it is preferable that the optical system according to the embodiment of the present invention includes one or more cemented lenses in which a cemented surface is convex toward the object side and a refractive index of a medium on the object side is higher than a refractive index of a medium on the image surface side, between the aperture diaphragm S and the last lens group GL. By disposing one or more cemented lenses in which a cemented surface is convex toward the object side and a refractive index of a medium on the object side is higher than a refractive index of a medium on the image surface side, at a position closer to the image surface side than the aperture diaphragm S, various aberrations such as comatic aberration and spherical aberration can be suppressed.

Furthermore, it is preferable that the optical system according to the embodiment of the present invention satisfies the following conditional expression.

$$- 2.2 < T T / E X P < - 1. \qquad ( 1 )$$

TT: surface distance from the surface closest to the object side in the first lens group G1 to the image surface in the infinity focusing state
EXP: air equivalent length on optical axis from exit pupil to image surface in infinity-focusing state, assuming that distance on image side is positive and distance on object side is negative relative to image surface.

Conditional Expression (1) is a conditional expression for appropriately setting the total length of the lens of the optical system and the distance from the exit pupil to the image surface. By satisfying Conditional Expression (1), it is possible to bring the position of the exit pupil of the optical system closer to the image side, and it is possible to shorten the total length of the optical system.

In a case where the value of Conditional Expression (1) is less than the lower limit and the position of the exit pupil is close to the image side, it is possible to sufficiently bring the position of the exit pupil of the optical system close to the image side. However, since the outermost angle ray highly diverges, it is difficult to ensure sufficient back focus or telecentricity, which is not preferable.

It is not preferable that the height of the off axis ray in the last lens group GL increases and the size thereof decreases in a case where the position of the exit pupil is brought closer to the object side beyond the upper limit value of Conditional Expression (1).

In addition, it is preferable that the upper limit value of Conditional Expression (1) is −1.20, since the effect of the present invention can be further achieved. Further, it is more preferable that the upper limit value of Conditional Expression (1) is −1.50 since the effect of the present invention can be further achieved.

Furthermore, it is preferable that the optical system according to the embodiment of the present invention includes a third lens group G3 having a positive refractive power between the second lens group G2 and the aperture diaphragm S, and satisfies the following conditional expression.

$$0.50 < f / f 3 < 1.00 \qquad ( 2 )$$

f: focal length of entire optical system in infinity-focusing state
f3: focal length of third lens group G3 in infinity focusing state

By disposing the third lens group G3 having a positive refractive power between the second lens group G2 and the aperture diaphragm S, the diameter of the second lens group G2 that moves during focusing can be suppressed, and the weight of the driving component and the product outer diameter can be suppressed. Further, since the action of converging the luminous flux by the third lens group G3 is performed, it is possible to suppress the diameter of the luminous flux passing through the aperture diaphragm S.

It is desirable that no group other than the third lens group G3 is present between the second lens group G2 and the aperture diaphragm S. In a case where a group other than the third lens group G3 is included, the total length of the lens increases, and it is difficult to suppress the product outer diameter.

In addition, it is desirable that the third lens group G3 includes an aspherical lens having a positive refractive power. By disposing the aspherical lens in the third lens group G3 in which the ray height on the axis is increased, it is possible to effectively suppress spherical aberration. Further, by using the aspherical lens, it is possible to perform spherical aberration correction while the number of positive lenses in the third lens group G3 is small. Accordingly, the length of the third lens group G3 on the optical axis can be suppressed, which contributes to the reduction of the total length of the lens.

Conditional Expression (2) specifies a ratio of a focal length of the entire optical system to a focal length of the third lens group G3 in the infinity focusing state. By satisfying Conditional Expression (2), it is possible to achieve both reduction in product outer diameter and correction of various aberrations.

It is not preferable that the refractive power of the third lens group G3 is decreased and the value of Conditional Expression (2) is below the lower limit, because the convergence effect of the rays by the third lens group G3 is weakened, the incidence angle of the ray emitted from the second lens group G2 and the ray incident on the aperture diaphragm S is relaxed, and it is difficult to suppress the diameter of the rays passing through the focusing lens group and the aperture diaphragm.

In a case where the refractive power of the third lens group G3 is increased beyond the upper limit value of Conditional Expression (2), it is possible to suppress the diameters of the second lens group G2 and the aperture diaphragm S. However, correction of spherical aberration and comatic aberration is insufficient, which is not preferable.

In addition, it is preferable that the upper limit value of Conditional Expression (2) is 0.92, since the effect of the present invention can be further achieved. In addition, it is preferable that the lower limit value of Conditional Expression (2) is 0.60, since the effect of the present invention can be further achieved.

Furthermore, in the optical system according to the embodiment of the present invention, it is preferable that the first lens group G1 consists of, in order from the object side, a front first lens group GIA consisting of only a negative meniscus lens having a negative refractive power and has a surface convex toward the object side, and a rear first lens group G1B having a positive refractive power, and the first lens group G1 satisfies the following conditional expression.

$$- 30.0 < f 1 b / f 1 a < - 4.0 \qquad ( 3 )$$

f1a: focal length of front first lens group GIA in infinity-focusing state
f1b: focal length of rear first lens group GIB in infinity-focusing state

The first lens group G1 is composed of a negative front first lens group GIA and a positive rear first lens group G1B, and the first lens group G1 plays a role close to that of a wide converter and realizes a wide angle of view while ensuring a back focus. Among these, the front first lens group GIA is composed of only negative meniscus lenses convex toward the object side, and effectively acts on the prevention of occurrence of off axis aberrations, particularly, distortion and astigmatism. In addition, by using an aspherical lens in the front first lens group GIA, it is possible to further enhance the effect of correcting distortion and astigmatism, which is more desirable.

Conditional Expression (3) is a conditional expression for appropriately setting a ratio of the focal length of the front first lens group GIA to the focal length of the rear first lens group G1B. By satisfying Conditional Expression (3), it is possible to secure a wide angle of view and a back focus while appropriately correcting distortion.

It is not preferable that the wide angle of view and the back focus cannot be secured in a case where the positive refractive power of the rear first lens group G1B is increased or the negative refractive power of the front first lens group GIA is decreased beyond the upper limit value of Conditional Expression (3).

It is not preferable that the negative distortion is highly generated in a case where the positive refractive power of the rear first lens group GIB is weakened or the negative refractive power of the front first lens group GIA is strengthened by lowering the value of Conditional Expression (3) below the lower limit.

It is preferable that the lower limit value of Conditional Expression (3) is −25.0 since the effect of the present invention can be further achieved. Further, it is more preferable that the lower limit value of Conditional Expression (3) is −18.0 since the effect of the present invention can be further achieved.

In addition, it is preferable that the upper limit value of Conditional Expression (3) is −4.50, since the effect of the present invention can be further achieved. Further, it is more preferable that the upper limit value of Conditional Expression (3) is −4.90 and further −6.50, since the effects of the present invention can be further achieved.

Furthermore, it is preferable that the optical system according to the embodiment of the present invention includes a rear lens group Gr, and the rear lens group Gr is configured to include a third lens group G3 having a positive refractive power and a last lens group GL, and preferably satisfies the following conditional expression.

$$0.70 < B {r}^{∧} 2 \times ( 1 - B {2}^{∧} 2 ) < 1.25 \qquad ( 4 )$$

B2: lateral magnification of second lens group G2 in infinity-focusing state
Br: lateral magnification of rear lens group Gr in infinity focusing state

Conditional Expression (4) specifies the focus sensitivity of the second lens group G2. By satisfying Conditional Expression (4), it contributes to suppression of the total length of the lens and reduction of the manufacturing error of the second lens group G2.

In a case where the focus sensitivity of the second lens group G2 is decreased by lowering the value of Conditional Expression (4) below the lower limit, the amount of focus movement is increased, and it is difficult to suppress the total length of the lens.

In addition, in a case where the focus sensitivity of the second lens group G2 is increased beyond the upper limit value of Conditional Expression (4), it is difficult to ensure the stop position accuracy of the focusing lens group during focusing. In addition, the eccentricity sensitivity of the second lens group G2 is also increased, and the variation in aberration due to the manufacturing error is increased, which is not preferable.

It is preferable that the lower limit value of Conditional Expression (4) is 0.75 since the effect of the present invention can be further achieved. Further, it is more preferable that the upper limit value of Conditional Expression (4) is 0.80 since the effect of the present invention can be further achieved.

Furthermore, in the optical system according to the embodiment of the present invention, it is preferable that the negative lens LN is an aspherical lens and satisfies the following conditional expression.

$$θ R 1 < 0 \qquad ( 5 )$$

$$θ R 2 > 0 \qquad ( 6 )$$

Here, in the inclination angle of the lens surface, an angle inclined toward the image surface side is positive and an angle inclined toward the object side is negative relative to a surface perpendicular to the optical axis, and
θR1: inclination angle of the object side surface R1 of the negative lens LN with respect to the surface perpendicular to the optical axis at a height where maximum image height principal ray passes through the surface R1
θR2: inclination angle of the object side surface R2 of the negative lens LN with respect to the surface perpendicular to the optical axis at a height where maximum image height principal ray passes through the surface R2

As described above, the last lens group GL is disposed at a position where a difference between an on-axis ray height and an off-axis ray height is large. In a lens group that allows such a ray to pass, it is possible to highly correct the off-axis aberration. Therefore, in the last lens group GL, by disposing the aspherical lens, it is possible to effectively correct the field curvature and the astigmatism, and to achieve both the size reduction and the high image formation performance at the same time.

Conditional Expression (5) specifies an angle of a surface of the negative lens LN with respect to the surface perpendicular to the optical axis at a height at which the principal ray passing through the maximum image height of the object side surface R1 of the negative lens LN passes. In addition, Conditional Expression (6) specifies an angle of a surface of the negative lens LN with respect to the surface perpendicular to the optical axis at a height at which the principal ray passing through the maximum image height of the image side surface R2 passes.

By satisfying Conditional Expressions (5) and (6), the negative lens LN is an aspherical lens having a biconcave shape at a height through which the principal ray having the maximum image height passes. In this way, the negative lens LN has a strong negative refractive power at a height at which the off-axis ray passes with respect to the on-axis ray, and thus it is possible to effectively correct the above-mentioned field curvature or astigmatism, which is desirable. The negative lens LN may have a biconcave shape at a height at which the principal rays with the maximum image heights on the object side surface and the image side surface pass. Therefore, the shape of the aspherical surface may be a gullwing shape having a point of inflection.

Furthermore, in the optical system according to the embodiment of the present invention, it is preferable that the second lens group G2 has a negative refractive power. In a case where a lens group having a negative refractive power closer to the object side than the aperture diaphragm S moves from the image side to the object side along the optical axis, there is a feature that negative distortion occurs significantly from infinity to a short distance and the object side incidence angle on the short distance side is the largest. By setting the second lens group G2, which is the focusing lens group, to have a negative refractive power and ensuring the amount of light on the infinity side where the object side incidence angle is small, the flare cut of the lower ray on the close side is facilitated.

Furthermore, in the optical system according to the embodiment of the present invention, it is preferable that the groups other than the second lens group G2 are fixed with respect to the image surface during focusing. By fixing the groups other than the second lens group G2 to the image surface during focusing, the number of actuators and drive mechanisms for driving the lens group can be minimized, and there is an advantage in achieving reduction in product outer diameter.

Next, lens configurations of examples according to the optical system of the present invention will be described. In the following description, the lens configuration will be described in order from the object side to the image surface side.

### Example 1

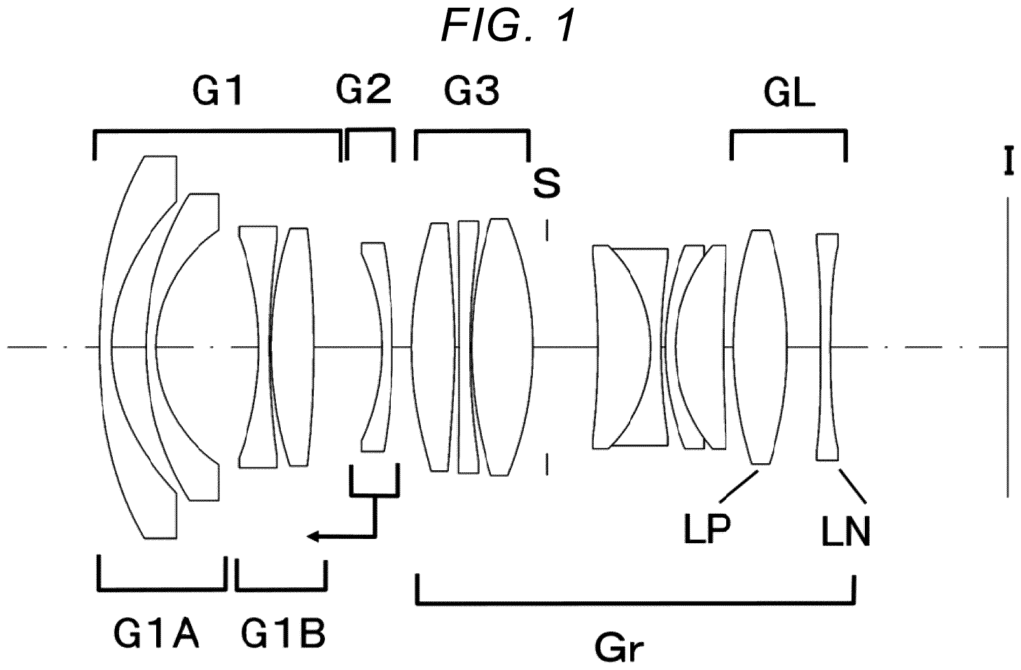

FIG. 1 is a lens configuration diagram of an optical system of Example 1 of the present invention. The optical system of Example 1 is composed of the first lens group G1 having a negative refractive power, the second lens group G2 having a negative refractive power, and the rear lens group Gr having a positive refractive power, in this order from the object side. The rear lens group Gr is configured to include, in order from the object side, a third lens group G3 having a positive refractive power, an aperture diaphragm S, and a last lens group GL closest to the image side. The focus from infinity to a close range is performed by moving the second lens group G2 from the image side to the object side.

The first lens group G1 is composed of a front first lens group GIA having a negative refractive power, and a rear first lens group G1B having a positive refractive power. The front first lens group GIA is composed of a negative meniscus lens of which both surfaces are aspherical surfaces and which has a convex surface toward the object side, and a negative meniscus lens of which a convex surface is directed toward the object side. The rear first lens group GIB is composed of a negative lens having a biconcave shape and a positive lens having a biconvex shape.

The second lens group G2 is composed of a negative meniscus lens having a convex surface toward the image side.

The rear lens group Gr is composed of a third lens group G3, an aperture diaphragm S, a cemented lens consisting of a positive meniscus lens convex toward the image side and a negative lens having a biconcave shape, a cemented lens consisting of a negative meniscus lens convex toward the object side and a positive meniscus lens convex toward the object side, and a last lens group GL. The third lens group G3 is composed of a positive lens having a biconvex shape and an aspherical surface on both surfaces, a negative lens having a biconcave shape, and a positive lens having a biconvex shape. The last lens group GL is composed of a positive lens LP having a biconvex shape, and a negative lens LN having a biconcave shape in which both surfaces are aspherical.

### Example 2

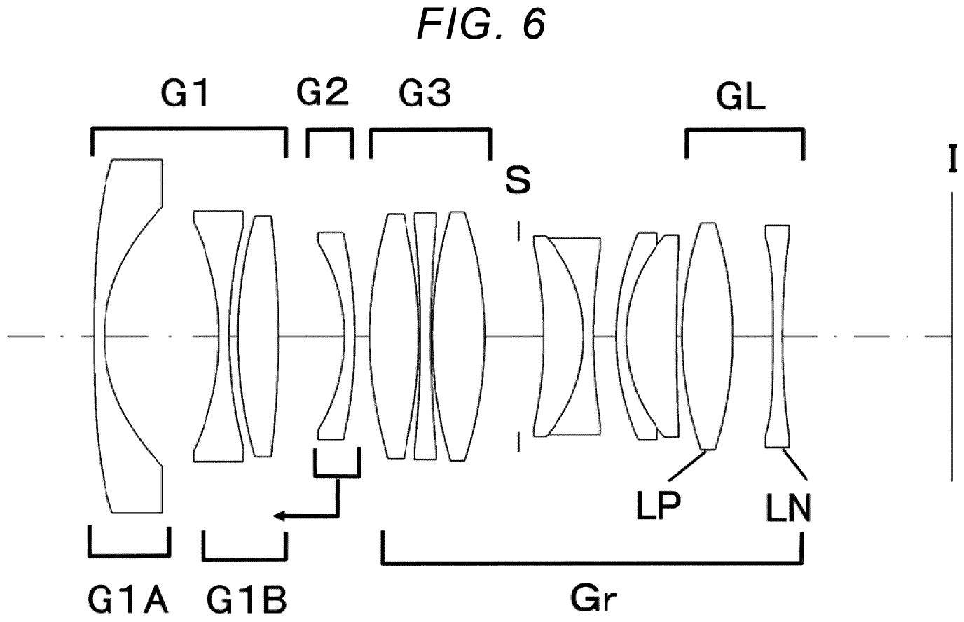

FIG. 6 is a lens configuration diagram of an optical system of Example 2 of the present invention. The optical system of Example 2 is composed of the first lens group G1 having a negative refractive power, the second lens group G2 having a negative refractive power, and the rear lens group Gr having a positive refractive power, in this order from the object side. The rear lens group Gr is configured to include, in order from the object side, a third lens group G3 having a positive refractive power, an aperture diaphragm S, and a last lens group GL closest to the image side. The focus from infinity to a close range is performed by moving the second lens group G2 from the image side to the object side.

The first lens group G1 is composed of a front first lens group GIA having a negative refractive power, and a rear first lens group G1B having a positive refractive power. The front first lens group GIA is composed of negative meniscus lenses of which both surfaces are aspherical surfaces and which are convex toward the object side. The rear first lens group GIB is composed of a negative lens having a biconcave shape and a positive lens having a biconvex shape.

The second lens group G2 is composed of a negative meniscus lens having a convex surface toward the image side.

The rear lens group Gr is composed of a third lens group G3, an aperture diaphragm S, a cemented lens consisting of a positive meniscus lens convex toward the image side and a negative lens having a biconcave shape, a cemented lens consisting of a negative meniscus lens convex toward the object side and a positive meniscus lens convex toward the object side, and a last lens group GL. The third lens group G3 is composed of a positive lens having a biconvex shape and an aspherical surface on both surfaces, a negative lens having a biconcave shape, and a positive lens having a biconvex shape. The last lens group GL is composed of a positive lens LP having a biconvex shape, and a negative lens LN having a biconcave shape in which both surfaces are aspherical.

### Example 3

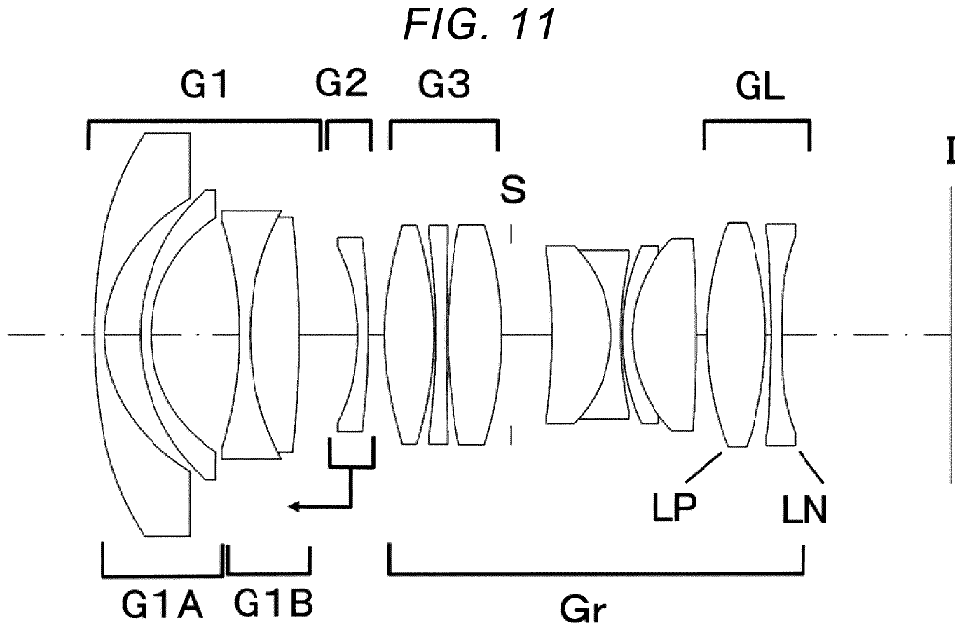

FIG. 11 is a lens configuration diagram of an optical system of Example 3 of the present invention. The optical system of Example 3 is composed of the first lens group G1 having a negative refractive power, the second lens group G2 having a negative refractive power, and the rear lens group Gr having a positive refractive power, in this order from the object side. The rear lens group Gr is configured to include, in order from the object side, a third lens group G3 having a positive refractive power, an aperture diaphragm S, and a last lens group GL closest to the image side. The focus from infinity to a close range is performed by moving the second lens group G2 from the image side to the object side.

The first lens group G1 is composed of a front first lens group GIA having a negative refractive power, and a rear first lens group G1B having a positive refractive power. The front first lens group GIA is composed of a negative meniscus lens of which both surfaces are aspherical surfaces and which has a convex surface toward the object side, and a negative meniscus lens of which a convex surface is directed toward the object side. The rear first lens group GIB is configured by a cemented lens consisting of a negative lens having a biconcave shape and a positive lens having a biconvex shape.

The second lens group G2 is composed of a negative meniscus lens having a convex surface toward the image side.

The rear lens group Gr is composed of the third lens group G3, the aperture diaphragm S, a cemented lens consisting of a positive meniscus lens convex toward the image side and a negative lens having a biconcave shape, a cemented lens consisting of a negative meniscus lens convex toward the object side and a positive lens having a biconvex shape, and the last lens group GL. The third lens group G3 is composed of a positive lens having a biconvex shape and an aspherical surface on both surfaces, a negative lens having a biconcave shape, and a positive lens having a biconvex shape. The last lens group GL is composed of a positive lens LP having a biconvex shape, and a negative lens LN having a biconcave shape in which both surfaces are aspherical.

### Example 4

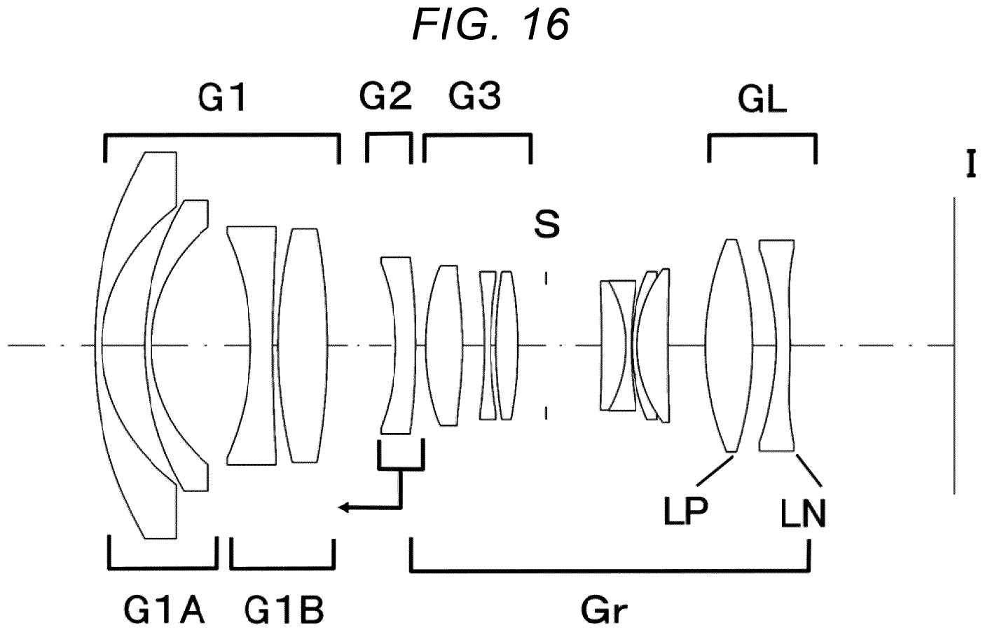

FIG. 16 is a lens configuration diagram of an optical system of Example 4 of the present invention. The optical system of Example 4 is composed of the first lens group G1 having a negative refractive power, the second lens group G2 having a negative refractive power, and the rear lens group Gr having a positive refractive power, in this order from the object side. The rear lens group Gr is configured to include, in order from the object side, a third lens group G3 having a positive refractive power, an aperture diaphragm S, and a last lens group GL closest to the image side. The focus from infinity to a close range is performed by moving the second lens group G2 from the image side to the object side.

The first lens group G1 is composed of a front first lens group GIA having a negative refractive power, and a rear first lens group GB having a positive refractive power. The front first lens group GIA is composed of a negative meniscus lens of which both surfaces are aspherical surfaces and which has a convex surface toward the object side, and a negative meniscus lens of which a convex surface is directed toward the object side. The rear first lens group G1B is composed of a negative lens having a biconcave shape, and a positive lens having a biconvex shape.

The second lens group G2 is composed of a negative meniscus lens having a convex surface toward the image side.

The rear lens group Gr is composed of a third lens group G3, an aperture diaphragm S, a cemented lens consisting of a positive meniscus lens convex toward the image side and a negative lens having a biconcave shape, a cemented lens consisting of a negative meniscus lens convex toward the object side and a positive meniscus lens convex toward the object side, and a last lens group GL. The third lens group G3 is composed of a positive lens having a biconvex shape and an aspherical surface on both surfaces, a negative lens having a biconcave shape, and a positive lens having a biconvex shape. The last lens group GL is composed of a positive lens LP having a biconvex shape, and a negative lens LN of which both surfaces are aspherical surfaces, the object side is a concave surface, and the image side is a gullwing shape.

### Example 5

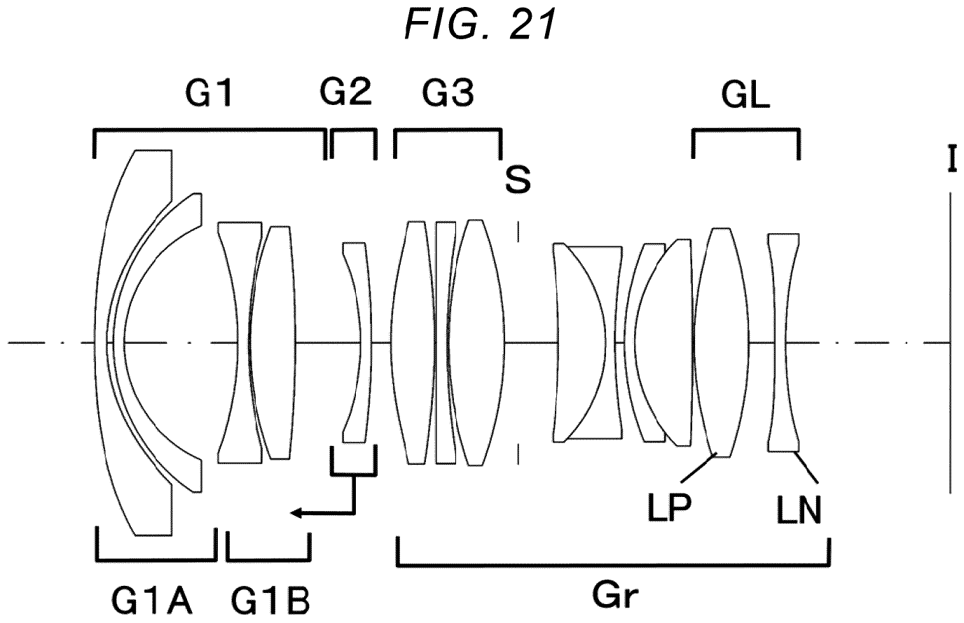

FIG. 21 is a lens configuration diagram of an optical system of Example 5 of the present invention. The optical system of Example 5 is composed of the first lens group G1 having a negative refractive power, the second lens group G2 having a negative refractive power, and the rear lens group Gr having a positive refractive power in this order from the object side. The rear lens group is configured to include, in order from the object side, a third lens group G3 having a positive refractive power, an aperture diaphragm S, and a last lens group GL closest to the image side. The focus from infinity to a close range is performed by moving the second lens group G2 from the image side to the object side.

The first lens group G1 is composed of a front first lens group GIA having a negative refractive power, and a rear first lens group G1B having a positive refractive power. The front first lens group GIA is composed of a negative meniscus lens of which both surfaces are aspherical surfaces and which has a convex surface toward the object side, and a negative meniscus lens of which a convex surface is directed toward the object side. The rear first lens group GIB is composed of a negative lens having a biconcave shape, and a positive lens having a biconvex shape.

The second lens group G2 is composed of a negative meniscus lens having a convex surface toward the image side.

The rear lens group Gr is composed of a third lens group G3, an aperture diaphragm S, a cemented lens consisting of a positive meniscus lens convex toward the image side and a negative lens having a biconcave shape, a cemented lens consisting of a negative meniscus lens convex toward the object side and a positive lens having a biconvex shape, and a last lens group GL. The third lens group G3 is composed of a positive lens having a biconvex shape and an aspherical surface on both surfaces, a negative lens having a biconcave shape, and a positive lens having a biconvex shape. The last lens group GL is composed of a positive lens LP having a biconvex shape, and a negative lens LN having a biconcave shape in which both surfaces are aspherical.

Specific numerical data of each example according to the imaging optical system of the present invention will be shown below.

In [Surface data], the surface number is a number of a lens surface or an aperture diaphragm counted from the object side, r is a curvature radius of each surface, d is a distance between surfaces, nd is a refractive index with respect to a d ray (wavelength of 587.56 nm), and vd is an Abbe number with respect to the d line.

An asterisk (*) attached to a surface number indicates that the lens surface shape is an aspherical surface shape. In addition, BF represents a back focus.

The (diaphragm) attached to the surface number indicates that the aperture diaphragm is located at that position. In a case of a curvature radius with respect to a plane or an aperture diaphragm, ∞ (infinity) is written.

[Aspherical surface data] shows values of each coefficient for giving the aspherical shape of the lens surface denoted by * in [Surface data]. In a case where a displacement from the optical axis in a direction perpendicular to the optical axis is y, a displacement (sag) from an intersection of the optical axis and the aspherical surface in an optical axis direction is z, a curvature radius of a reference spherical surface is r, a conic coefficient is K, and fourth-order, sixth order, eighth order, . . . , and eighteenth-order aspherical coefficients are A4, A6, A8, . . . , and A18, respectively, it is assumed that coordinates of the aspherical surface are represented by the following expression.

$$z = \frac{( 1 / r ) {y}^{2}}{1 + \sqrt{1 - ( 1 + K ) {( \frac{y}{r} )}^{2}}} + A 4 {y}^{4} + A 6 {y}^{6} + A 8 {y}^{8} + A 10 {y}^{10} + A 12 {y}^{12} + A 14 {y}^{14} + A 16 {y}^{16} + A 18 {y}^{18}$$

[Various types of data] indicate values such as a focal length in each focusing distance-focused state.

The [Variable distance data] shows the variable distance and the BF value in each focusing distance-focused state.

The [Lens group data] shows the surface number closest to the object side in each lens group and the total focal length of the entire group.

In addition, in the values of all the specifications described below, unless otherwise noted, the units of the focal length f, the curvature radius r, the lens surface distance d, and other lengths are millimeters (mm), but the present invention is not limited thereto since the same optical performance can be obtained in both the proportional magnification and the proportional reduction in the optical system.

In addition, in the aberration diagrams corresponding to the respective examples, d, g, and C represent a d ray, a g ray, and a C ray, respectively, and ΔS and ΔM represent a sagittal image surface and a meridional image surface, respectively.

### Numerical Example 1

Unit: mm
[Surface data]

| Surface number | r | d | nd | vd |
|---|---|---|---|---|
| Object surface | ∞ | (d0) | | |
| 1* | 51.0090 | 1.2000 | 1.69350 | 53.20 |
| 2* | 17.0037 | 3.1783 | | |
| 3 | 28.0382 | 1.0000 | 1.61800 | 63.40 |
| 4 | 13.5087 | 9.6254 | | |
| 5 | −30.6094 | 1.0000 | 1.59282 | 68.62 |
| 6 | 77.6748 | 0.1500 | | |
| 7 | 37.5738 | 4.0291 | 1.94594 | 17.98 |
| 8 | −105.7421 | (d8) | | |
| 9 | −21.7200 | 1.0000 | 1.90110 | 27.06 |
| 10 | −60.3791 | (d10) | | |
| 11* | 35.7924 | 4.0664 | 1.80610 | 40.73 |
| 12* | −70.4603 | 0.4255 | | |
| 13 | −770.8464 | 1.0000 | 1.69895 | 30.05 |
| 14 | 77.6725 | 0.1500 | | |
| 15 | 41.4071 | 5.7164 | 1.75500 | 52.32 |
| 16 | −33.0901 | 1.4000 | | |
| 17 (diaphragm) | ∞ | 4.7714 | | |
| 18 | −79.7342 | 4.9414 | 1.69350 | 50.81 |
| 19 | −13.6448 | 0.9500 | 1.94594 | 17.98 |
| 20 | 56.4882 | 0.4091 | | |
| 21 | 25.5583 | 0.9500 | 1.84666 | 23.84 |
| 22 | 15.1416 | 4.4957 | 1.59282 | 68.62 |
| 23 | 141.0284 | 1.0066 | | |
| 24 | 37.1800 | 5.0236 | 1.98612 | 16.48 |
| 25 | −37.1800 | 3.0971 | | |
| 26* | −400.0000 | 1.0000 | 1.80610 | 40.73 |
| 27* | 127.8500 | (BF) | | |
| Image surface | ∞ | | | |

[Aspherical surface data]

| | Surface 1 | Surface 2 | Surface 11 | Surface 12 | Surface 26 |
|---|---|---|---|---|---|
| K | 0.00000 | −1.00000 | 0.00000 | 0.00000 | 0.00000 |
| A4 | 1.31560E−05 | 1.68730E−05 | −1.08825E−05 | 1.72766E−05 | −3.20873E−05 |
| A6 | −6.19834E−08 | −8.66163E−08 | 2.53703E−07 | 2.39932E−07 | 2.57014E−07 |
| A8 | 3.83875E−10 | 8.25356E−10 | −6.43577E−09 | −5.96424E−09 | −2.63031E−09 |
| A10 | −1.43272E−12 | −5.71469E−12 | 9.52718E−11 | 8.61358E−11 | 7.07714E−13 |
| A12 | 2.94648E−15 | 2.73868E−14 | −7.79452E−13 | −6.74993E−13 | 5.06286E−14 |
| A14 | −2.49140E−18 | −9.25046E−17 | 3.01436E−15 | 2.43764E−15 | −1.01483E−16 |
| A16 | 0.00000E+00 | 2.02761E−19 | −4.35900E−18 | −3.18931E−18 | 0.00000E+00 |
| A18 | 0.00000E+00 | −2.14912E−22 | 0.00000E+00 | 0.00000E+00 | 0.00000E+00 |

| | Surface 27 |
|---|---|
| K | 0.00000 |
| A4 | 2.15722E−05 |
| A6 | 3.22870E−07 |
| A8 | −1.31472E−09 |
| A10 | −1.44838E−11 |
| A12 | 1.45826E−13 |
| A14 | −3.58030E−16 |
| A16 | 0.00000E+00 |
| A18 | 0.00000E+00 |

[Various types of data]

| | INF | 170 mm |
|---|---|---|
| Focal length | 12.33 | 11.75 |
| F number | 1.46 | 1.46 |
| Total angle of view 2ω | 103.29 | 105.89 |
| Image height Y | 14.20 | 14.20 |
| Total length of lens | 85.36 | 85.36 |

[Variable distance data]

| | INF | 170 mm |
|---|---|---|
| d0 | ∞ | 85.0203 |
| d8 | 6.3767 | 4.8808 |
| d10 | 1.8000 | 3.2959 |
| BF | 16.5939 | 16.5939 |

[Lens group data]

| Group | Starting surface | Focal length |
|---|---|---|
| G1 | 1 | −26.15 |
| G2 | 9 | −38.11 |
| G3 | 11 | 17.04 |
| GL | 24 | 22.22 |
| G1A | 1 | −19.09 |
| G1B | 5 | 131.40 |
| Gr | 11 | 20.44 |

### Numerical Example 2

Unit: mm
[Surface data]

| Surface number | r | d | nd | vd |
|---|---|---|---|---|
| Object surface | ∞ | (d0) | | |
| 1* | 306.2592 | 1.0000 | 1.59271 | 66.97 |
| 2* | 16.0000 | 11.1494 | | |
| 3 | −26.9779 | 1.0000 | 1.49700 | 81.61 |
| 4 | 45.4526 | 0.8208 | | |
| 5 | 44.4476 | 3.9437 | 1.94594 | 17.98 |
| 6 | −101.0893 | (d6) | | |
| 7 | −18.2719 | 1.0000 | 1.80809 | 22.76 |
| 8 | −48.1020 | (d8) | | |
| 9* | 36.5372 | 4.7903 | 1.80610 | 40.73 |
| 10* | −42.5784 | 0.1500 | | |
| 11 | −111.6779 | 1.0000 | 1.58144 | 40.89 |
| 12 | 121.2362 | 0.1500 | | |
| 13 | 44.5649 | 5.0706 | 1.76385 | 48.49 |
| 14 | −40.2168 | 3.3820 | | |
| 15 (diaphragm) | ∞ | 2.3509 | | |
| 16 | −43.3761 | 3.8864 | 1.72916 | 54.54 |
| 17 | −15.2057 | 0.9500 | 1.94594 | 17.98 |
| 18 | 57.8564 | 2.2700 | | |
| 19 | 25.6742 | 0.9500 | 1.84666 | 23.84 |
| 20 | 14.9876 | 4.8944 | 1.59282 | 68.62 |
| 21 | 215.2149 | 0.5287 | | |
| 22 | 35.3360 | 4.9209 | 1.94594 | 17.98 |
| 23 | −37.7209 | 3.9554 | | |
| 24* | −300.0000 | 0.9000 | 1.80610 | 40.73 |
| 25* | 84.7180 | (BF) | | |
| Image surface | ∞ | | | |

[Aspherical surface data]

| | Surface 1 | Surface 2 | Surface 9 | Surface 10 | Surface 24 |
|---|---|---|---|---|---|
| K | 0.00000 | −1.00000 | 0.00000 | 0.00000 | 0.00000 |
| A4 | 2.85811E−05 | 2.97514E−05 | −1.69015E−05 | 9.43241E−06 | −3.89483E−05 |
| A6 | −1.76360E−07 | −1.49309E−07 | 1.60716E−07 | 1.49179E−07 | −7.11162E−07 |
| A8 | 1.00261E−09 | 1.41934E−09 | −4.42193E−09 | −4.35539E−09 | 8.39779E−09 |
| A10 | −3.29730E−12 | −1.55128E−11 | 7.30769E−11 | 6.86979E−11 | −5.27984E−11 |
| A12 | 5.87430E−15 | 1.38170E−13 | −6.48984E−13 | −5.73786E−13 | 1.83008E−13 |
| A14 | −4.22567E−18 | −6.42806E−16 | 2.78627E−15 | 2.31917E−15 | −2.45719E−16 |
| A16 | 0.00000E+00 | 1.18870E−18 | −4.48918E−18 | −3.53084E−18 | 0.00000E+00 |
| A18 | 0.00000E+00 | −4.78462E−22 | 0.00000E+00 | 0.00000E+00 | 0.00000E+00 |

| | Surface 25 |
|---|---|
| K | 0.00000 |
| A4 | 2.50629E−05 |
| A6 | −7.28358E−07 |
| A8 | 1.09050E−08 |
| A10 | −8.31975E−11 |
| A12 | 3.36311E−13 |
| A14 | −5.49777E−16 |
| A16 | 0.00000E+00 |
| A18 | 0.00000E+00 |

[Various types of data]

| | INF | 168 mm |
|---|---|---|
| Focal length | 14.58 | 13.65 |
| F number | 1.46 | 1.46 |
| Total angle of view 2ω | 93.79 | 97.67 |
| Image height Y | 14.20 | 14.20 |
| Total length of lens | 83.38 | 83.38 |

[Variable distance data]

| | INF | 168 mm |
|---|---|---|
| d0 | ∞ | 85.0203 |
| d6 | 6.3937 | 4.4314 |
| d8 | 1.5000 | 3.4623 |
| BF | 16.4276 | 16.4276 |

[Lens group data]

| Group | Starting surface | Focal length |
|---|---|---|
| G1 | 1 | −33.65 |
| G2 | 7 | −37.02 |
| G3 | 9 | 16.41 |
| GL | 22 | 24.14 |
| G1A | 1 | −28.52 |
| G1B | 3 | 415.26 |
| Gr | 9 | 20.77 |

### Numerical Example 3

Unit: mm
[Surface data]

| Surface number | r | d | nd | vd |
|---|---|---|---|---|
| Object surface | ∞ | (d0) | | |
| 1* | 61.9033 | 1.0000 | 1.69350 | 53.20 |
| 2* | 13.1591 | 3.3649 | | |
| 3 | 18.6623 | 1.0000 | 1.59410 | 60.47 |
| 4 | 13.3187 | 8.4108 | | |
| 5 | −36.7756 | 1.0000 | 1.59282 | 68.62 |
| 6 | 25.4611 | 4.6367 | 1.94594 | 17.98 |
| 7 | −104.2540 | (d7) | | |
| 8 | −19.4250 | 1.0000 | 1.90110 | 27.06 |
| 9 | −73.9152 | (d9) | | |
| 10* | 29.6712 | 4.7206 | 1.80610 | 40.73 |
| 11* | −31.3770 | 0.1500 | | |
| 12 | −75.1313 | 1.0000 | 1.69895 | 30.05 |
| 13 | 337.5237 | 0.1500 | | |
| 14 | 52.7050 | 5.0666 | 1.75500 | 52.32 |
| 15 | −35.4377 | 1.0000 | | |
| 16 (diaphragm) | ∞ | 3.7802 | | |
| 17 | −60.1910 | 5.6504 | 1.71700 | 47.98 |
| 18 | −12.2436 | 0.9500 | 1.94594 | 17.98 |
| 19 | 36.1977 | 0.1500 | | |
| 20 | 21.4166 | 0.9500 | 1.84666 | 23.84 |
| 21 | 13.3465 | 6.0173 | 1.61800 | 63.40 |
| 22 | −142.9590 | 1.1081 | | |
| 23 | 30.4943 | 5.5039 | 1.98612 | 16.48 |
| 24 | −33.0934 | 0.5693 | | |
| 25* | −53.9991 | 1.0000 | 1.80610 | 40.73 |
| 26* | 499.1257 | (BF) | | |
| Image surface | ∞ | | | |

[Aspherical surface data]

| | Surface 1 | Surface 2 | Surface 10 | Surface 11 | Surface 25 |
|---|---|---|---|---|---|
| K | 0.00000 | −1.00000 | 0.00000 | 0.00000 | 0.00000 |
| A4 | 2.20013E−05 | 4.00246E−05 | −2.43672E−05 | 1.28801E−05 | 1.95248E−04 |
| A6 | −9.75959E−08 | −7.03487E−08 | 2.12140E−07 | 2.49763E−07 | −1.89983E−06 |
| A8 | 4.82992E−10 | 1.58297E−09 | −4.50211E−09 | −6.34849E−09 | 1.08107E−09 |
| A10 | −1.36568E−12 | −1.25462E−11 | 6.76590E−11 | 8.43606E−11 | 2.88436E−11 |
| A12 | 1.98050E−15 | 7.43533E−14 | −6.74712E−13 | −4.99744E−13 | 8.32482E−14 |
| A14 | −1.16572E−18 | −8.11907E−17 | 4.01722E−15 | 2.96105E−16 | −1.21183E−15 |
| A16 | 0.00000E+00 | −8.06533E−19 | −1.28900E−17 | 3.71614E−18 | 0.00000E+00 |
| A18 | 0.00000E+00 | 1.88065E−21 | 0.00000E+00 | 0.00000E+00 | 0.00000E+00 |

| | Surface 26 |
|---|---|
| K | 0.00000 |
| A4 | 2.67068E−04 |
| A6 | −1.50901E−06 |
| A8 | −2.67669E−09 |
| A10 | 6.71912E−11 |
| A12 | −2.02724E−13 |
| A14 | −2.65012E−16 |
| A16 | 0.00000E+00 |
| A18 | 0.00000E+00 |

[Various types of data]

| | INF | 166 mm |
|---|---|---|
| Focal length | 10.67 | 10.29 |
| F number | 1.46 | 1.46 |
| Total angle of view 2ω | 111.30 | 113.64 |
| Image height Y | 14.20 | 14.20 |
| Total length of lens | 81.35 | 81.35 |

[Variable distance data]

| | INF | 166 mm |
|---|---|---|
| d0 | ∞ | 85.0203 |
| d7 | 5.6333 | 4.6634 |
| d9 | 1.5000 | 2.4699 |
| BF | 16.0358 | 16.0358 |

[Lens group data]

| Group | Starting surface | Focal length |
|---|---|---|
| G1 | 1 | −23.61 |
| G2 | 8 | −29.50 |
| G3 | 10 | 14.48 |
| GL | 23 | 22.22 |
| G1A | 1 | −17.94 |
| G1B | 5 | 140.84 |
| Gr | 10 | 19.69 |

### Numerical Example 4

Unit: mm
[Surface data]

| Surface number | r | d | nd | vd |
|---|---|---|---|---|
| Object surface | ∞ | (d0) | | |
| 1* | 92.2523 | 1.3000 | 1.69350 | 53.20 |
| 2* | 28.8150 | 7.8107 | | |
| 3 | 53.9448 | 1.3000 | 1.61800 | 63.40 |
| 4 | 28.5990 | 18.1097 | | |
| 5 | −51.7858 | 4.0000 | 1.59282 | 68.62 |
| 6 | 360.8981 | 0.9547 | | |
| 7 | 92.0552 | 9.0000 | 1.94594 | 17.98 |
| 8 | −126.2337 | (d8) | | |
| 9 | −44.5022 | 3.6723 | 1.85883 | 30.00 |
| 10 | −129.1758 | (d10) | | |
| 11* | 47.5243 | 6.7500 | 1.80610 | 40.73 |
| 12* | −76.8746 | 3.9406 | | |
| 13 | −97.9762 | 1.2000 | 1.69895 | 30.05 |
| 14 | 78.8121 | 1.0051 | | |
| 15 | 88.8891 | 3.9540 | 1.75500 | 52.32 |
| 16 | −75.8032 | 5.2595 | | |
| 17 (diaphragm) | ∞ | 10.0821 | | |
| 18 | −273.5868 | 4.3501 | 1.71700 | 47.98 |
| 19 | −24.4974 | 1.0000 | 1.94594 | 17.98 |
| 20 | 73.6513 | 0.1500 | | |
| 21 | 35.2572 | 1.0000 | 1.85896 | 22.73 |
| 22 | 24.0827 | 5.5469 | 1.59282 | 68.62 |
| 23 | 392.1620 | 6.8773 | | |
| 24 | 52.8787 | 8.6221 | 1.98612 | 16.48 |
| 25 | −68.3617 | 4.2447 | | |
| 26* | −39.7336 | 2.6669 | 1.80610 | 40.73 |
| 27* | −96.5353 | (BF) | | |
| Image surface | ∞ | | | |

[Aspherical surface data]

| | Surface 1 | Surface 2 | Surface 11 | Surface 12 | Surface 26 |
|---|---|---|---|---|---|
| K | 0.00000 | −1.00000 | 0.00000 | 0.00000 | 0.00000 |
| A4 | 2.86494E−06 | 4.76453E−06 | 7.80014E−08 | 4.51624E−06 | 2.92444E−05 |
| A6 | −3.49172E−09 | −1.22529E−09 | 1.43401E−08 | 1.33306E−08 | −6.48243E−08 |
| A8 | 4.27653E−12 | 4.76754E−12 | −4.89073E−11 | −1.50770E−11 | −9.86470E−12 |
| A10 | −2.83171E−15 | −1.29722E−14 | 7.44655E−13 | 3.79382E−13 | 1.96020E−13 |
| A12 | 5.50366E−19 | 3.24181E−17 | −3.46056E−15 | −1.51648E−15 | −2.11654E−16 |
| A14 | 6.46668E−23 | −2.05564E−20 | 9.86156E−18 | 6.02080E−18 | −3.01691E−20 |
| A16 | 0.00000E+00 | −3.46375E−23 | −4.09931E−21 | 2.11385E−22 | 0.00000E+00 |
| A18 | 0.00000E+00 | 3.13417E−26 | 0.00000E+00 | 0.00000E+00 | 0.00000E+00 |

| | Surface 27 |
|---|---|
| K | 0.00000 |
| A4 | 3.72227E−05 |
| A6 | −5.05387E−08 |
| A8 | −1.67101E−11 |
| A10 | 1.17735E−13 |
| A12 | −2.22669E−17 |
| A14 | −1.71307E−19 |
| A16 | 0.00000E+00 |
| A18 | 0.00000E+00 |

[Various types of data]

| | INF | 355 mm |
|---|---|---|
| Focal length | 23.49 | 22.46 |
| F number | 2.20 | 2.20 |
| Total angle of view 2ω | 103.71 | 106.06 |
| Image height Y | 27.39 | 27.39 |
| Total length of lens | 157.04 | 157.04 |

[Variable distance data]

| | INF | 355 mm |
|---|---|---|
| d0 | ∞ | 197.7670 |
| d8 | 12.5186 | 9.6756 |
| d10 | 1.8000 | 4.6430 |
| BF | 29.9233 | 29.9233 |

[Lens group data]

| Group | Starting surface | Focal length |
|---|---|---|
| G1 | 1 | −60.80 |
| G2 | 9 | −80.67 |
| G3 | 11 | 35.7551 |
| GL | 24 | 44.7337 |
| G1A | 1 | −35.8829 |
| G1B | 5 | 183.4814 |
| Gr | 11 | 40.5793 |

### Numerical Example 5

Unit: mm
[Surface data]

| Surface number | r | d | nd | vd |
|---|---|---|---|---|
| Object surface | ∞ | (d0) | | |
| 1* | 73.7430 | 1.2000 | 1.69350 | 53.20 |
| 2* | 16.4848 | 0.6059 | | |
| 3 | 17.1623 | 1.0000 | 1.61800 | 63.40 |
| 4 | 12.1543 | 10.6596 | | |
| 5 | −30.9373 | 1.0000 | 1.59282 | 68.62 |
| 6 | 39.6952 | 0.1500 | | |
| 7 | 31.7701 | 4.2303 | 1.94594 | 17.98 |
| 8 | −111.2827 | (d8) | | |
| 9 | −21.7464 | 1.0000 | 1.90110 | 27.06 |
| 10 | −74.0733 | (d10) | | |
| 11* | 32.9508 | 4.1226 | 1.80610 | 40.73 |
| 12* | −59.0880 | 0.1500 | | |
| 13 | −9664.6324 | 1.0000 | 1.68960 | 31.14 |
| 14 | 67.3955 | 0.1500 | | |
| 15 | 36.5569 | 5.2035 | 1.75500 | 52.32 |
| 16 | −34.1545 | 1.4000 | | |
| 17 (diaphragm) | ∞ | 3.7477 | | |
| 18 | −68.9407 | 4.3808 | 1.69350 | 50.81 |
| 19 | −13.4053 | 0.9500 | 1.94594 | 17.98 |
| 20 | 54.2421 | 0.8715 | | |
| 21 | 24.8707 | 0.9500 | 1.84666 | 23.84 |
| 22 | 14.0169 | 5.4157 | 1.59282 | 68.62 |
| 23 | −250.0959 | 0.1500 | | |
| 24 | 33.6474 | 5.1220 | 1.98612 | 16.48 |
| 25 | −34.4555 | 2.4905 | | |
| 26* | −400.0000 | 1.0000 | 1.80610 | 40.73 |
| 27* | 42.3261 | (BF) | | |
| Image surface | ∞ | | | |

[Aspherical surface data]

| | Surface 1 | Surface 2 | Surface 11 | Surface 12 | Surface 26 |
|---|---|---|---|---|---|
| K | 0.00000 | −1.00000 | 0.00000 | 0.00000 | 0.00000 |
| A4 | 2.61987E−05 | 2.77667E−05 | −2.26553E−05 | 1.09896E−05 | −7.48544E−05 |
| A6 | −1.00041E−07 | −8.99777E−08 | 2.31793E−07 | 2.08557E−07 | 4.29889E−07 |
| A8 | 4.14494E−10 | 7.23699E−10 | −6.02988E−09 | −5.97925E−09 | −5.75434E−09 |
| A10 | −1.30369E−12 | −6.34484E−12 | 8.61474E−11 | 8.77406E−11 | 2.62865E−11 |
| A12 | 2.60088E−15 | 3.52536E−14 | −6.86851E−13 | −6.97869E−13 | 4.14381E−15 |
| A14 | −2.21632E−18 | −1.64187E−16 | 2.65112E−15 | 2.64649E−15 | −1.43120E−16 |
| A16 | 0.00000E+00 | 5.93044E−19 | −3.87050E−18 | −3.73121E−18 | 0.00000E+00 |
| A18 | 0.00000E+00 | −9.34423E−22 | 0.00000E+00 | 0.00000E+00 | 0.00000E+00 |

| | Surface 27 |
|---|---|
| K | 0.00000 |
| A4 | −3.25629E−06 |
| A6 | 6.86364E−07 |
| A8 | −8.18289E−09 |
| A10 | 5.78391E−11 |
| A12 | −2.27442E−13 |
| A14 | 3.44025E−16 |
| A16 | 0.00000E+00 |
| A18 | 0.00000E+00 |

[Various types of data]

| | INF | 165 mm |
|---|---|---|
| Focal length | 12.17 | 11.53 |
| F number | 1.46 | 1.46 |
| Total angle of view 2ω | 103.96 | 106.55 |
| Image height Y | 14.20 | 14.20 |
| Total length of lens | 80.41 | 80.41 |

[Variable distance data]

| | INF | 165 mm |
|---|---|---|
| d0 | ∞ | 85.0203 |
| d8 | 6.2049 | 4.8303 |
| d10 | 1.8000 | 3.1747 |
| BF | 15.4539 | 15.4539 |

[Lens group data]

| Group | Starting surface | Focal length |
|---|---|---|
| G1 | 1 | −26.11 |
| G2 | 9 | −34.47 |
| G3 | 11 | 15.663 |
| GL | 24 | 25.1304 |
| G1A | 1 | −21.1482 |
| G1B | 5 | 211.4237 |
| Gr | 11 | 17.9925 |

In addition, a list of corresponding values of the conditional expressions in each of these examples is shown.

TABLE 1

| | | Example | | | | |
|---|---|---|---|---|---|---|
| | Conditional expression | EX1 | EX2 | EX3 | EX4 | EX5 |
| (1) | −2.2 < TT/EXP < −1.0 | −1.81 | −1.95 | −1.60 | −1.94 | −2.06 |
| (2) | 0.50 < f/f3 < 1.00 | 0.724 | 0.889 | 0.737 | 0.657 | 0.777 |
| (3) | −30.0 < f1b/f1a < −4.0 | −6.88 | −14.56 | −7.85 | −5.11 | −10.00 |
| (4) | 0.70 < Br\hat{ }2 × (1 − B2\hat{ }2) < 1.25 | 1.023 | 1.084 | 1.199 | 0.861 | 1.092 |
| (5) | θR1 < 0 | −4.91 | −9.43 | −7.11 | −16.89 | −7.97 |
| (6) | θR2 > 0 | 9.37 | 6.34 | 18.43 | 9.50 | 13.53 |

### DESCRIPTION OF REFERENCE NUMERALS AND SIGNS

G1: first lens group
G2: second lens group
G3: third lens group
GL; last lens group
G1A: front first lens group
G1B: rear first lens group
Gr: rear lens group
LP: positive lens
LN: negative lens
S: aperture diaphragm
I: image surface
C: C ray (wavelength λ=656.3 nm)
d: d ray (wavelength λ=587.6 nm)
g: g ray (wavelength λ=435.8 nm)

What is claimed is:

1. An optical system comprising, in order from an object side: a first lens group G1 having a negative refractive power; a second lens group G2 that moves along an optical axis during focusing from infinity to a short distance; and a last lens group GL that is disposed closest to an image surface side,
wherein the optical system further comprises an aperture diaphragm S disposed between the second lens group G2 and the last lens group GL.

2. The optical system according to claim 1,
wherein the last lens group GL is composed of a positive lens LP and a negative lens LN arranged in this order from the object side.

3. The optical system according to claim 1,
wherein the second lens group G2 moves from an image side to the object side along the optical axis during focusing from the infinity to the short distance.

4. The optical system according to claim 1, further comprising: at least one cemented lenses in which a cemented surface is convex toward the object side and a refractive index of a medium on the object side is higher than a refractive index of a medium on the image surface side, between the aperture diaphragm S and the last lens group GL.

5. The optical system according to claim 1,
wherein following conditional expression is satisfied,
$$- 2.2 < T T / E X P < - 1. \qquad ( 1 )$$
where
TT: surface distance from surface of the first lens group G1 closest to the object side to image surface in infinity focusing state
EXP: air equivalent length on the optical axis from exit pupil to the image surface in infinity focusing state, assuming that distance on the image side is positive and distance on the object side is negative relative to the image surface.

6. The optical system according to claim 1, further comprising: a third lens group G3 having a positive refractive power, disposed between the second lens group G2 and the aperture diaphragm S,
wherein following conditional expression is satisfied,
$$0.5 < f / f 3 < 1.00 \qquad ( 2 )$$
where f: focal length of entire optical system in an infinity focusing state
f3: focal length of the third lens group G3 in the infinity-focusing state.

7. The optical system according to claim 1,
wherein the first lens group G1 consists of, in order from the object side, a front first lens group GIA consisting of only a negative meniscus lens having a negative refractive power and that is convex toward the object side, and a rear first lens group G1B having a positive refractive power, and following conditional expression is satisfied,
$$- 30. 0 < f 1 b / f 1 a < - 4.0 \qquad ( 3 )$$
where
f1a: focal length of the front first lens group GIA in infinity-focusing state
f1b: focal length of the rear first lens group GIB in infinity focusing state.

8. The optical system according to claim 1, further comprising: a rear lens group Gr,
wherein the rear lens group Gr includes a third lens group G3 having a positive refractive power and the last lens group GL, and following conditional expression is satisfied,
$$0.7 < B {r}^{∧} 2 \times ( 1 - B {2}^{∧} 2 ) < 1.25 \qquad ( 4 )$$
where
B2: lateral magnification of the second lens group G2 in an infinity-focusing state
Br: lateral magnification of the rear lens group Gr in the infinity-focusing state.

9. The optical system according to claim 2,
wherein the negative lens LN is an aspherical lens, and following conditional expression is satisfied,
$$θ R 1 < 0 \qquad ( 5 )$$
$$θ R 2 > 0 \qquad ( 6 )$$
here, in an inclination angle of a lens surface, an angle inclined toward the image surface side is positive and an angle inclined toward the object side is negative relative to a surface perpendicular to the optical axis,
where
θR1: inclination angle of an object side surface R1 of the negative lens LN with respect to the surface perpendicular to the optical axis at a height where maximum image height principal ray passes through the surface R1
θR2: inclination angle of an object side surface R2 of the negative lens LN with respect to the surface perpendicular to the optical axis at a height where maximum image height principal ray passes through the surface R2.

10. The optical system according to claim 3,
wherein the second lens group G2 has a negative refractive power.

11. The optical system according to claim 1,
wherein groups other than the second lens group G2 are fixed with respect to an image surface during focusing.
